(19) United States
(12) Patent Application Publication
(10) Pub. No.: US 2024/0424490 A1
(43) Pub. Date: Dec. 26, 2024

(54) METHOD OF SYNTHESIS OF CARBON-SUPPORTED PLATINUM GROUP METAL OR METAL ALLOY NANOPARTICLES

(71) Applicant: Uniwersytet Warszawski, Warszawa (PL)

(72) Inventors: Pawel WNUK, Warszawa (PL); Adam LEWERA, Warszawa (PL); Rafal JURCZAKOWSKI, Brwinów (PL); Filip POWALA, Warszawa (PL); Jan KOLODZIEJCZYK, Warszawa (PL)

(73) Assignee: Uniwersytet Warszawski, Warszawa (PL)

(21) Appl. No.: 18/274,031

(22) PCT Filed: Jan. 24, 2022
(86) PCT No.: PCT/PL2022/000002

§ 371 Date: Jul. 25, 2023

(30) Foreign Application Priority Data
Jan. 25, 2021 (PL) P.436764

(51) Int. Cl. B01J 37/02; B01J 21/18; B01J 23/42; B01J 23/44; B01J 23/46; B01J 35/00; B01J 37/08; B01J 37/16; B82Y 40/00

(52) U.S. Cl. CPC B01J 37/0209; B01J 21/18; B01J 23/42; B01J 23/44; B01J 23/464; B01J 23/468; B01J 35/19; B01J 37/0203; B01J 37/0205; B01J 37/0213; B01J 37/084; B01J 37/16; B82Y 40/00

(57) ABSTRACT

The presented invention relates to a method of synthesis of carbon-supported platinum group metal or metal alloy nanoparticles, which comprises the following steps:
adsorbing on carbon support complexes of a platinum group metal with a urea complexing agent selected from a group comprising urea, urea derivative, a mixture of urea with at least one urea derivative, and a mixture of at least two urea derivatives; and
reducing the complexes adsorbed on the carbon support to metal nanoparticles, forming a product of carbon-supported metal nanoparticles.

The invention also provides the use of the carbon-supported platinum group metal or metal alloy nanoparticles obtained by the method of the invention as catalyst.

The present invention further relates to a method of adsorption of precursors of platinum group metals on the surface of a carbon support and use of complexes of platinum group metals with urea complexing agent for adsorption of platinum group metal precursors on carbon support.

### TECHNICAL FIELD

The presented invention relates to a method of synthesis of carbon-supported platinum group metal or metal alloy nanoparticles. The invention also provides use of the carbon-supported platinum group metal or metal alloy nanoparticles obtained by the method of the invention as catalyst.

### BACKGROUND ART

In the literature a description of many methods of synthesis of carbon-supported platinum group metals can be found. Among them, the most commonly applied methods include: impregnation-reduction, Bönneman, water in oil microemulsion and polyol methods. (C. Coutanceau, S. Baranton and T. W. Napporn (2012). Platinum Fuel Cell Nanoparticle Syntheses: Effect on Morphology, Structure and Electrocatalytic Behavior, The Delivery of Nanoparticles, Dr. Abbass A. Hashim (Ed.), ISBN: 978-953-51-0615-9, InTech). Depending on the method used, the obtained catalysts are characterized by different morphology, nanoparticle size and distribution and catalytic properties. The method of the present invention can be classified as a variant of impregnation-reduction method. However, it has many advantages over the methods known in the prior art, such as simplicity, versatility, better utilization of noble metal due to larger active surface area and low-costs.

The method of the present invention utilizes the urea- or urea-derivative complexes of platinum-group metal as a precursors for carbon-supported platinum group metal nanoparticle synthesis. To date the only use of urea in the nanoparticle synthesis was to adjust pH of the reagents during reduction of non-urea precursor of Pt (H₂PtCl₆) (Baizeng Fang, Nitin K. Chaudhari, Min-Sik Kim, Jung Ho Kim, and Jong-Sung Yu* Homogeneous Deposition of Platinum Nanoparticles on Carbon Black for Proton Exchange Membrane Fuel Cell J. Am. Chem. Soc. 2009, 131, 15330-15338. Yu et al. U.S. Pat. No. 8,993,198 B2). It should be stressed that in the background art the only application of urea for synthesis of noble metal nanoparticles is to control the pH of the reducing agent.

### DISCLOSURE OF INVENTION

The presented invention relates to a method of synthesis of carbon-supported platinum group metal or metal alloy nanoparticles. As used herein, the platinum group metals (PGMs) consist of six elements-platinum (Pt), palladium (Pd), rhodium (Rh), iridium (Ir), ruthenium (Ru) and osmium (Os), whereas metal alloys comprise any two or more component alloys of PGMs, including alloys with other platinum group metals, alloys with metals other than PGMs, as well as alloys with nonmetal elements. Since the carbon-supported platinum group metal or metal alloy nanoparticles can be used as catalysts, the method of the invention is a novel method of catalyst synthesis.

The method of synthesis according to the invention comprises the following steps:
(b) adsorbing on carbon support complexes of a platinum group metal with a urea complexing agent; and
(c) reducing the metal from the complexes adsorbed on the carbon support as obtained in step (b) to metal nanoparticles to form a product of carbon-supported metal nanoparticles. As used herein the terms ‘metal-urea complexing agent complex’ or ‘complex of metal with a urea complexing agent’ are defined as a coordination complex containing a platinum group metal as the central ion and at least one molecule of urea or urea derivative as ligand(s). This definition also includes mixed ligand complexes, in which in addition to urea or urea derivative ligands, other ligands are present, for example ammonia, chloride ions, cyanide ions or nitrite ions. According to the present invention the urea complexing agent is selected from a group consisting of urea and urea derivatives, a mixture of urea with at least one urea derivative, and a mixture of at least two urea derivatives. As used herein, the urea derivative should be understood as a compound containing a —HN—CO— functional group, preferably —HN—CO—NH— functional group. In particular, such urea derivatives are selected from a group comprising methylurea, N,N-dimethylurea, N,N′-dimethylurea, ethylurea, trimethylurea, N,N-diethylurea, N,N′-diethylurea, N,N′-bis(hydroxymethyl) urea, and their analogs, such as bis(hydroxymethyl) urea, urea condensation products including biuret, biurets, triuret, biuret-derivatives containing —(HN—CO—)₂N— functional group, other carbamides, urea-containing oligomers or polymers such as urea-formaldehyde, etc., and other ureas and carbamates. Preferably, the complexes of a platinum group metal with a urea complexing agent are selected from a group comprising urea, methylurea, N,N-dimethylurea, N,N′-dimethylurea, ethylurea, trimethylurea, N,N-diethylurea, N,N′-diethylurea, N,N′-bis(hydroxymethyl)urea, bis(hydroxymethyl)urea. More preferably, the complexes of a platinum group metal with a urea complexing agent are selected from a group comprising urea, methylurea and N,N′-dimethylurea. It is important for the method of the invention that a compound containing a —HN—CO— functional group, preferably —HN—CO—NH— functional group, is used as a complexing agent. The results obtained by the inventors suggest that the urea complexing agent binds the platinum group metals via nitrogen atoms and binds to the surface of carbon support via oxygen atoms. This provides a very good coverage of the platinum group metals on the carbon support.

Moreover, it should be understood that complexes of platinum group metals adsorbed on carbon support comprise complexes of a single platinum group metal, preferably Pt, Pd or Ir, or complexes of two or more platinum group metals. In the latter case, the reduction of the adsorbed complexes results in metal alloy nanoparticle formation. The complexes of two or more platinum group metals can be absorbed on the carbon support simultaneously or they can be adsorbed consecutively (i.e. one after the other). The process of simultaneous adsorption is carried out when two or more complexes of different platinum group metals are present in the solution, in which the carbon support is immersed. In this case the complexes of at least two platinum group metals are adsorbed on the surface of the carbon support at the same time. The process in which different complexes of platinum group metals are adsorbed on the surface of the carbon support one after the other comprises many adsorption steps, in which adsorption of a first platinum group metal complex is followed by adsorption of a second complex of a different platinum metal complex. This latter process can be carried out by immersing the carbon support in a first solution of the platinum group complex and after the desired level of complex adsorption is achieved, the carbon support is transferred to another solution comprising a second complex of a different platinum group metal, wherein the said complex undergoes adsorption. It should be noted that the process of the platinum group complex adsorption can be repeated more than once.

Preferably the method of the invention steps (b) and (c) are preceded by step (a), in which a platinum group metal precursor, preferably K₂PtCl₄, K₂PdCl₄ and IrCl₄, is reacted with a urea complexing agent selected from a group comprising urea derivatives, and a mixture of urea with at least one urea derivative or a mixture of at least two urea derivatives, in a solution, to form complexes of metal-urea complexing agent, wherein the urea derivatives are defined above.

In one embodiment of the method of the invention, steps (a) and (b) are carried out concurrently (i.e. they form one step). In this embodiment platinum group metal precursor and urea or urea derivative are mixed with carbon support to form a suspension, wherein the suspension is heated, so that the metal-urea or urea derivative complexes are formed and adsorbed on the carbon-support. Subsequently the complexes adsorbed on the carbon support undergo the reduction step (c) resulting in a formation of metal nanoparticles.

In another embodiment steps (a) and (b) are carried out separately (i.e. a multistep process is carried out), and the complexes obtained in step (a) are subsequently mixed with the carbon support to enable adsorption of the complexes onto the carbon support. Subsequently, the complexes adsorbed on the carbon support undergo the reduction step (c), which results in formation of metal nanoparticles.

In accordance with any of the above embodiments, steps (a) of the metal-urea or urea derivative complex formation and (b) of adsorbing said metal-urea or urea derivative complexes onto carbon support are preferably carried out in an aqueous solution.

Preferably, in step (b) in addition to complexes of platinum group metal with a urea complexing agent, other platinum group metal precursors (salts, hydrates or complexes) can be adsorbed on the surface of the carbon support. Alternatively, in step (b) in addition to complexes of platinum group metal with a urea complexing agent, precursors (salts, hydrates or complexes) of metals other than platinum group metal can be adsorbed on the surface of the carbon support. Subsequently, a combination of at least two different metal precursors undergoes a reduction process. As a result alloy nanoparticles are obtained. Metals other than platinum group metals used to obtain alloy nanoparticles on a carbon support include metals selected from a group consisting of vanadium, chromium, manganese, iron, cobalt, nickel, copper, gold, silver and tin. Preferably, a metal other than a platinum group metal used to obtain alloy nanoparticles on a carbon support is nickel, silver or gold. As already described above, the adsorption process of complexes of platinum group metal with a urea complexing agent and precursors of metals other than platinum group metal can be carried out simultaneously (i.e. the platinum group metal complexes and precursors of metals other than platinum group metals can be present in one solution), or consecutively (i.e. the carbon support is transferred from one complex or precursor solution to another to effect absorption of respective complexes and precursors).

Alternatively, in step (b) in addition to complexes of platinum group metal with a urea complexing agent other precursors (salts, hydrates or complexes) of the same platinum group metal can be adsorbed on the surface of the carbon support. Subsequently, a combination of at least two different metal precursors in a form of different complexes of the same platinum group metal undergoes a reduction process. As a result, nanoparticles of a single platinum group metal are obtained. As discussed above, the adsorption of complexes of platinum group metal with a urea complexing agent other precursors of the same platinum group metal can be adsorbed simultaneously or consecutively.

The term “metal precursor” as used herein should be understood as any metal salt, hydrate or complex, which can be reduced to a metallic form, which is deposited on the carbon substrate. This term also includes a mixture of metal precursors, which undergo reduction forming an alloy. Moreover, the term “metal precursor” also covers any metal salt, hydrate or complex, which can be used to form complexes with a urea complexing agent.

According to the invention the platinum group metal precursor used in the method of the invention is preferably selected from a group comprising H₂PtCl₆, H₆Cl₂N₂Pt, PtCl₂, PtBr₂, K₂[PtCl₄], Na₂[PtCl₄], Li₂[PtCl₄], H₂Pt(OH)₆, Pt(NO₃)₂, [Pt(NH₃)₄]Cl₂, [Pt(NH₃)₄](HCO₃)₂, [Pt(NH₃)₄](OAc)₂, (NH₃)₄Pt(NO₃)₂, (NH₄)₂PtBr₆, K₂PtCl₆, PtSO₄, Pt(HSO₄)₂, Pt(ClO₄)₂, K₂PtI₆, K₂[Pt(CN)₄], cis-[Pt(NH₃)₂Cl₂], H₂PdCl₆, H₆Cl₂N₂Pd, PdCl₂, PdBr₂, K₂[PdCl₄], Na₂[PdCl₁], Li₂[PdCl₄], H₂Pd(OH)₆, Pd(NO₃)₂, [Pd(NH₃)₄]Cl₂, [Pd(NH₃)₄](HCO₃)₂, [Pd(NH₃)₄](OAc)₂, (NH₄)₂PdBr₆, (NH₃)₂PdCl₆, PdSO₄, Pd(HSO₄)₂, Pd(ClO₄)₂, Pd(OAc)₂, RuCl₂ ((CH₃)₂SO)₄, RuCl₃, [Ru(NH₃)₅(N₂)]Cl₂, Ru(NO₃)₃, RuBr₃, RuF₃, Ru(ClO₄)₃, K₂RuCl₆, OsI, OsI₂, OsBr₃, OsCl₄, OsF₅, OsF₆, OsOF₅, OsF₇, IrBr₄, IrF₆, IrCl₃, IrF₄, IrF₅, Ir(ClO₄)₃, K₃[IrCl₆], K₂[IrCl₆], Na₃[IrCl₆], Na₂[IrCl₆], Li₃[IrCl₆], Li₂[IrCl₆], [Ir(NH₃)₄Cl₂]Cl, RhF₃, RhF₄, RhCl₃, [Rh(NH₃)₅Cl₁]Cl₂, RhCl[P(C₆H₅)₃]₃, K[Rh(CO)₂Cl₂], Na[Rh(CO)₂Cl₂]Li[Rh(CO)₂Cl₂], Rh₂(SO₄)₃, Rh(HSO₄)₃ and Rh(ClO₄)₃, their hydrates and mixtures of these salts and/or hydrates. The most preferred PGM precursors are selected from the group comprising K₂PtCl₄, K₂PdCl₄, and IrCl₄. Alternatively, a PGM precursor can be selected from a group of water insoluble salts, such as PtCl₂, provided that it will be able to form a metal complex with urea or urea derivative.

The preferred precursors of metals other than platinum group metals that are used with platinum group metals to obtain alloy nanoparticles on carbon support are selected from a group comprising VSO₄(H₂O)ₓ, VCl₃, VBr₃, VF₃, VI₃, V₂O₃, V₂(SO₄)₃, VO(acac)2, CrBr₃, CrCl₃, [Cr(H2O)₆](NO₃)3·3H2O, CrI₃, [Cr₃O(O₂CCH₃)₆(OH₂)₃]Cl(H₂O)₆, Cr(ClO₄)₃, Cr₂(SO₄)₃·x(H₂O), Mn(O₂CCH₃)₃, Mn(CH₃CO₂)₂—(H₂O)ₙ, MnBr₂, MnCl₂, Mn(NO₃)₂—(H₂O)ₙ, Fe(O₂CCH₃)₂, FeCl₂, FeI₂, FeF₂, [Fe(H₂O)₆]²⁺{[Fe(C₆H₅O₇)(H₂O)]⁻}2·2H₂O, Fe(NO₃)₂·6H₂O, FeSO₄·xH₂O, Fe(BF₄)₂, Fe(C₃H₅O₃)(H₂O)ₙ, Fe₂(SO₄)₃(H₂O)ₙ, Fe(NO₃)₃·x H₂O, FeF₃(H₂O)ₓ, FeCl₃, Co(CH₃CO₂)₂·4 H₂O, CoBr₂, Co(ClO₃)₂, CoCl₂, CoF₂, Co(HCO₂)₂, CoI₂, Co(NO₃)₂·xH₂O, CoSO₄(H₂O)ₓ, Co(NO₃)₃, [Co(NH₃)₅Br]Br₂, [Co(NH₃)₅(NO₂)]Cl₂, [Co(NH₃)₆]Cl₃, Ni(NO₃)₂, Ni(NO₂)₂, NiSO₄(H₂O)₆, NiCl₂, NiCl₂·6H₂O, NiBr₂(H₂O)ₓ, NiI₂, NiF₂, Ni(CH₃CO₂)₂·x H₂O, CuCl₂, CuSO₄(H₂O)ₓ, Cu(NO₃)₂(H₂O)ₓ, Cu(ClO₃)₂, CuBr₂, Cu(OSO₂CF₃)₂, Cu(H₂O)ₓ(BF₄)₂, Cu₂(OAc)₄(H₂O)₂, AuCl₃, AuBr₃, HAuCl₄—(H₂O)ₓ, AgNO₃, AgC₂H₃O₂, AgNO₂, AgF, Ag₂SO₄, SnCl₂, SnCl₄, SnF₂, SnSO₄, SnBr₄, their hydrates and mixtures of these salts and/or hydrates.

In the preferred embodiment, the method of the invention between steps (b) and (c) also comprises a step, in which the carbon support with the adsorbed complexes is isolated from the solution, in which complex adsorption is carried out, and subsequently washed. The isolation step is preferably carried out by filtration. The washing step is carried out using water. In some embodiments the carbon support with the adsorbed complexes can be air-dried or dried in the atmosphere of an inert gas.

Also preferably, step (c) of the method of the invention, i.e. the step of reducing the said metal-urea or urea derivative complexes on carbon support, is carried out using gaseous hydrogen. In that specific embodiment, the method of the invention also comprises a step, in which the carbon support with the adsorbed complexes is isolated from the solution, in which complex adsorption is carried out. When the gaseous hydrogen is used, the reduction step is carried out in temperature 50-200° C. by placing the carbon support with the adsorbed complexes in a stream of a gas mixture consisting of hydrogen with an inert gas, preferably argon or nitrogen. Hydrogen content in the gas mixture is preferably in a range of 1-10%, more preferably 3-7%, and most preferably 4-6%. The reduction step is carried out preferably for 1 to 6 hours, more preferably 2 to 5 hours, and most preferably 3 to 4 hours with the flow rate of the gas mixture in the range of 5-30 ml/min. The hydrogen content in the gaseous reductive stream and the flow rate need to be adjusted to provide a significant stoichiometric excess of hydrogen (approximately 10 x) relative to the metal-urea complexing agent complex that undergoes reduction. Also preferably, before the reduction process takes place, the carbon support with the adsorbed complexes is placed in a stream of an inert gas, such as argon or nitrogen, to remove any residual oxygen. This step of removal of residual oxygen is carried out in ambient temperature or higher, but not exceeding 200° C., typically in the range of 20-150° C. Preferably the residual oxygen removal is carried out for about 1-3 hours. Moreover, the reduction step can be followed by a heat treatment (for example, in the temperature range of 50-350° C.), which is carried out in the atmosphere of an inert gas for 1-6 hours, in order to remove impurities or unreacted urea complexing agents adsorbed on the carbon support.

Alternatively, the reduction step in the method of the invention is carried out by thermal decomposition of the adsorbed complex of metal with a urea complexing agent in inert atmosphere. The decomposition process is carried out in the temperature range between 190-550° C. for 1-6 hours. Preferably, the reduction by decomposition is carried out in the inert gas selected from a group consisting of argon and nitrogen.

Yet in another embodiment, the metal complex reduction step (step (c)) is carried out in a solution, using a reducing agent, preferably L-ascorbic acid, sodium borohydride, formaldehyde or citric acid. Most preferably, L-ascorbic acid, sodium borohydride, or citric acid are used as the reducing agents when the metal complex reduction step is carried out in a solution Other reducing agents can also be contemplated, such as glucose, hydrazine, hydrazine sulfate, hydrazine nitrate, sodium hypophosphite, lithium borohydride, aluminium borohydride, lithium tetraethylborohydride, methanol, ethanol, formic acid, ethylene glycol, 1,2-hexadecanediol, hydroxylamine, and dimethylborazane DMAB.

Regardless of the reduction method, in the preferred embodiment of the method of the invention, a molar ratio of the urea complexing agent to metal used in step (a) is in the range 1-20:1, preferably 1-10:1, more preferably 1-6:1 and most preferably 1-4:1. More preferably, the molar ratio of the urea complexing agent to metal used in step (a) is selected from the group consisting of the following ratios: 20:1, 19:1, 18:1, 17:1, 16:1, 15:1, 14:1, 13:1, 12:1; 11:1; 10:1, 9:1, 8:1, 7:1, 6:1, 5:1, 4:1, 3:1, 2:1, 1.5:1 and 1:1. Most preferably, the molar ratio of the urea complexing agent to metal used in step (a) is selected from the group consisting of the following ratios: 4:1, 3:1, 2:1, 1.5:1 and 1:1, in particular are selected from 4:1, 2:1, and 1:1.

Moreover, in the method of the invention the amounts of the metal-urea complexing agent complexes and carbon support used in step (b) are adjusted to obtain the product comprising 0.001 to 60%, preferably 5 to 40%, more preferably 10 to 40%, most preferably 20 to 40% of metal by weight calculated based on the total weight of the product (i.e. metal nanoparticles and the carbon support). It should be noted that the upper limit of 60% of the metal content in the final product obtained by the method of the invention is arbitrary. It has been selected taking into account the use of the final product as a catalyst. However, it is possible to obtain a product of carbon-supported metal nanoparticles with a higher metal content. The metal content will be limited only by the surface area of the carbon support onto which the metal-urea complexing agent complexes are adsorbed.

The concentrations of the metal precursor solutions and urea complexing agent solutions, which are used in step (a) of the method of the invention, are in a range from 1 mM to 5M, preferably from 1 mM to 4 M, more preferably from 1 mM to 3 M, and most preferably from 1 mM to 2 M. By changing the concentration of the starting solutions of the metal precursor and the urea complexing agent and their amounts, the ratio between the metal and urea complexing agent in the complex formed in step (a) can be easily adjusted.

In the method of the invention, the solution comprising a platinum group metal precursor and a urea complexing agent is heated in step (a), under reflux, at the temperature of 40 to 100° C., preferably 50 to 90° C., and more preferably 60 to 80° C., to form complexes. This step (step (a)) is carried out from 10 minutes to 10 hours, preferably from 20 minutes to 5 hours, more preferably from 30 minutes to 4 hours, even more preferably from 30 minutes to 3 hours, and most preferably from 30 minutes to 2 hours. Alternatively, in step (a) of the method of the invention the solution comprising a platinum group metal precursor and urea or urea derivative is heated at 40 to 100° C., preferably 50 to 90° C., and more preferably 60 to 80° C., until all the liquid evaporates.

In another embodiment, to the aqueous solution used in step (a), an organic solvent, preferably isopropanol or ethanol, is added in a volumetric ratio of 0.05-30:1 calculated based on water volume in the solution. The ratio is adjusted depending on the effect to be achieved. Addition of a small amount of the organic solvent (0.05-0.5:1 volumetric ratio with respect to water) results in formation of different complexes of metal with urea complexing agent. When a significant amount of the organic solvent is used (10-30:1 volumetric ratio with respect to water), the formed complex of metal with urea complexing agent precipitates. This precipitate can be washed and subsequently dissolved in water for further use in the method of the invention (i.e. in step (b), in which the complexes of a platinum group metal with a urea complexing agent are adsorbed on carbon support).

In one of the embodiments, as described above, the method of the invention involves a one-step method of complex formation and complex adsorption, in which all reagents are mixed together at the beginning of the reaction, and metal complexes are formed in situ in the presence of the carbon support. In this embodiment a pre-weighted amount of carbon support is dispersed in water. Preferably, the carbon support is dispersed using an ultrasound bath for ca. 1-30 minutes and, more preferably, 1-5 minutes. A carbon support as used herein refers to any support consisting essentially of carbon. The suitable carbon supports include all commercially available carbon supports falling into such classes as: carbon blacks, sooth, carbon nanotubes, carbon nanofibers, ordered mesoporous carbons or carbon xerogels. The preferred carbon supports used in the method of invention are carbon blacks. In particular, commercially available carbon supports can be used, which are marketed under trade names, e.g. such as Vulcan® XC-72R (oil-furnace carbon black) and Ketjenblack® EC-300J (acetylene black). In general, selection of the carbon support does not significantly influence the method of the invention or the properties of the obtained product. Therefore, the method of the invention has a universal characteristic with respect to the carbon support used. The ratio of carbon to water is in the range of 1-50, preferably 5-20, and most preferably 5-10 mg of carbon per 1 ml of water. Next, solutions of metal precursors and urea or urea derivatives are added to the carbon suspension. The term “urea derivate” refers to any urea derivative capable of forming complexes with PGMs, and “urea derivative” should be understood as a compound containing a —HN—CO— functional group, preferably —HN—CO—NH— functional group. In particular, such urea derivatives are selected from a group comprising methylurea, N,N-dimethylurea, N,N′-dimethylurea, ethylurea, trimethylurea, N,N-diethylurea, N,N′-diethylurea, N,N′-bis(hydroxymethyl)urea, and their analogs, such as bis(hydroxymethyl)urea, urea condensation products including biuret, biurets, triuret, biuret-derivatives containing —(HN—CO—)₂N— functional group, other carbamides, urea-containing oligomers or polymers such as urea-formaldehyde, etc., and other ureas and carbamates. Preferably, the complexes of a platinum group metal with a urea complexing agent are selected from a group comprising urea, methylurea, N,N-dimethylurea, N,N′-dimethylurea, ethylurea, trimethylurea, N,N-diethylurea, N,N′-diethylurea, N,N′-bis(hydroxymethyl)urea, bis(hydroxymethyl)urea. More preferably the complexes of a platinum group metal with a urea complexing agent are selected from a group comprising urea, methylurea and N,N′-dimethylurea. It is important for the method of the invention that a compound containing a —HN—CO— functional group, preferably —HN—CO—NH— functional group, is used as a complexing agent. The present invention also contemplates the use of a mixture of urea and/or urea derivatives in the method of synthesis of the invention. Urea and derivatives thereof, as well as their mixtures, are also collectively referred to hereinbelow as a urea complexing agent. Also whenever a reference is made to urea or urea derivatives it should be also understood as covering a mixture of urea with at least one urea derivative or a mixture of different urea derivatives.

The concentrations of the solutions of both the precursor and urea complexing agent are typically in the range from 1 mM to 5 M. The amounts of the solutions used in the method of the invention are adjusted in order to obtain a desired metal mass content in the final product, i.e. the carbon-supported platinum group metal or metal alloy nanoparticles (preferably corresponding to 0.001-60% of total mass in the final sample of the carbon-supported platinum group metal or metal alloy nanoparticles) and the urea:metal molar ratio (preferably 1-10:1) in the suspension. The suspension is then heated, preferably at 40-100° C., under reflux for 1-10 hours, most preferably for 2-6 hours. Subsequently, the suspension (containing metal-urea complexing agent complexes adsorbed on carbon) is filtered, washed thoroughly with water and, next, reduced with either: 1) a solution, preferably an aqueous solution, of a reducing agent (i.e. wet reducing step), 2) dried under inert gas atmosphere (preferably, under argon or nitrogen atmosphere) or in vacuum and then reduced under hydrogen atmosphere, preferably under the atmosphere of a hydrogen mixture with an inert gas, preferably argon or nitrogen (i.e. dry reduction step) or 3) thermal decomposition of adsorbed metal-urea complex in inert atmosphere at temperature in the range 190-550° C. preferably 250-350° C. The reducing agent used in the solution in the wet reducing step in the method of the invention is, preferably, selected from a group comprising glucose, hydrazine, hydrazine sulfate, hydrazine nitrate, sodium hypophosphite, sodium borohydride, lithium borohydride, aluminum borohydride, lithium tetraethylborohydride, methanol, ethanol, formaldehyde, formic acid, ethylene glycol, 1,2-hexadecanediol, hydroxylamine, and dimethylborazane DMAB. L-ascorbic acid and citric acid are the particularly preferred reducing agents used in the method of the invention.

In the alternative embodiment, as described above, in which the synthesis of the invention involves a step of complex formation, which is followed by a separate step of complex adsorption on the carbon support (the multistep process), and subsequently the metal complex adsorbed on the surface of the carbon support undergoes the reduction process. In this embodiment, in the first step a metal-urea complex is synthetized using one of the following procedures:
(i) A urea complexing agent solution is added to a solution of metal precursor and then heated at 40-100° C. under reflux for 10 minutes-10 hours, preferably 10 minutes-2 hours. The concentrations of the solutions are typically in the range 1 mM-5 M and the amounts of the reagents are adjusted in order to obtain a 1-20:1 molar ratio of urea complexing agent to metal, most preferably 1-4:1.
(ii) A urea complexing agent solution is added to a solution of a metal precursor and then heated at 40-100° C. until all the liquid evaporates. The amounts of reagents are adjusted in order to obtain a 1-20:1 molar ratio of urea complexing agent to metal, most preferably 1-4:1. The obtained precipitate is either further heated at 40-100° C. or left under fume hood to evaporate the excess of liquid for 1-60 minutes and, next, dissolved in water, yielding a solution of metal-urea complex. The evaporation-dissolution procedure can be repeated several times, resulting in different metal-urea complexing agent complexes. For the evaporation process a vessel with a flat bottom surface, such as a Petri dish, is preferred, in order to ensure that the crystallization of a metal-urea complex proceeds more uniformly and reproducibly.
(iii) A water-insoluble metal precursor (such as PtCl₂) is mixed with a urea solution and then stirred and heated at 40-100° C. under reflux for 1-10 hours. The amounts of reagents are adjusted in order to obtain a 1-20:1 molar ratio of urea complexing agent to metal, most preferably 1-6:1.

Under certain conditions set in variants i), ii) and iii) of the complex formation, in particular in high temperature conditions (for example, above 100° C.), or using high urea complexing agent:metal ratio (for example, exceeding 10:1 of urea complexing agent:metal) and/or extensive duration of heating or evaporation processes (for example, exceeding 5 hours), water-insoluble complexes of metal-urea complexing agent can be obtained. Such compounds cannot be used in further steps of synthesis of carbon-supported nanoparticles. In the case when two phases (solid and liquid) are obtained in the synthesis (both containing metal-urea complexing agent complexes), the liquid phase is used in further steps. Insoluble complex formation depends on the metal and urea complexing agent used in the process. Nevertheless, the specific reaction conditions leading to formation of insoluble complexes are different for different reagents.

Importantly, different metal-urea complexing agent complexes are obtained, depending on the age of the metal precursor solutions used and their storage conditions (such as temperature), due to the ongoing hydrolysis process.

The method of complex synthesis described above (all variants (i), (ii) and (iii)) can be modified by addition of an organic solvent. In particular, after a complex of metal-urea complexing agent is obtained in the solution, a small amount (0.05-0.5:1 volumetric ratio with respect to water) of an organic solvent is added, resulting in a solution containing different complexes of metal-urea complexing agent, as compared to the water solution without addition of an organic solvent. In a preferred embodiment, the organic solvent is selected from a group comprising isopropanol or ethanol.

If the higher amount of alcohol is added, the complex of metal-urea complexing agent is precipitated. In particular, after a solution of metal-urea complex is obtained, a high amount (10-30:1 volumetric ratio with respect to water) of an organic solvent is added, resulting in precipitation of the metal-urea complexing agent complex. The precipitate is then washed several times with the organic solvent and, next, dissolved in water, yielding a solution of metal-urea complexing agent complex. The organic solvent used for complex precipitation is preferably selected from a group comprising isopropanol or ethanol.

It should be taken into account that when certain solvents (such as alcohols) are used in the above described modifications of complex synthesis, the metal-urea complexing agent complexes can be reduced by the solvent, forming precipitates of metal nanoparticles, which is not a desired process in synthesis of highly-dispersed carbon-supported nanoparticles.

In the second step of the multistep synthesis method of the invention, a pre-weighted amount of carbon support is dispersed in water. The ratio of carbon to water is in the range of 1-50, preferably 5-20, and most preferably 5-10 mg carbon per 1 ml of water. Preferably the carbon support is dispersed using an ultrasound bath for ca. 1-30 minutes and, more preferably, 1-5 minutes. Next, an adjusted amount(s) of a solution or different solutions comprising complexes of metal-urea complexing agents are added (preferably corresponding to 0.001-60% of the platinum group metal relative to the total mass in the final sample). The sample is then left for 1 minute-10 hours, until the metal-urea complex adsorbs on carbon surface (usually indicated by change of solution color) or can be heated under reflux at 40-100° C. for 1-4 hours. Most preferably, the sample is not stirred, in order to limit the amount of oxygen present in the sample. Without being bound to any theory, oxygen has a detrimental effect on the adsorption process, due to formation of hydrophobic domains on the carbon surface. Subsequently, the obtained suspension (containing metal-urea complexing agent precursor adsorbed on carbon) is filtered, washed thoroughly with water and, afterwards, reduced.

The reduction step is carried out as described above for the one-step synthesis method of the invention. In particular, the suspension (containing metal-urea complexing agent complexes adsorbed on carbon) is filtered, washed thoroughly with water and, next, reduced with either a solution, preferably an aqueous solution, of a reducing agent aqueous (i.e. wet reducing step) or dried under inert gas atmosphere (preferably, under argon or nitrogen atmosphere) and then reduced under hydrogen atmosphere, preferably under the atmosphere of a hydrogen mixture with an inert gas, preferably argon or nitrogen (i.e. dry reduction step) or by thermal decomposition in inert atmosphere. The reducing agent in the solution used in the wet reducing step in the method of the invention is preferably selected from a group comprising glucose, hydrazine, hydrazine sulfate, hydrazine nitrate, sodium hypophosphite, sodium borohydride, lithium borohydride, aluminum borohydride, lithium tetraethylborohydride, methanol, ethanol, formaldehyde, formic acid, ethylene glycol, 1,2-hexadecanediol, hydroxylamine, and dimethylborazane DMAB. L-ascorbic acid and citric acid are the particularly preferred reducing agents used in the method of the invention.

The most preferred metal reduction method for any of the above-presented embodiments is the dry reduction method, wherein the metal in the metal-urea complexing agent is reduced under a hydrogen atmosphere.

In both one-step and multistep methods of synthesis according to the invention, water solutions are preferably used. However, in an alternative embodiment any other solvents can be used (for instance, water-isopropanol or water-acetone mixture), provided that urea or urea derivatives and metal precursors are soluble in such a solvent mixture. In case, when in the multistep process, a complex synthesis is carried out until evaporation of the liquid (method described under item (ii) above), the use of solvents with lower surface tension than water or the use of their mixtures with water, results in a more uniform and reproducible process of crystallization of metal-urea complexing agent complexes. The choice of the solvent significantly influences the type of obtained metal-urea complexing agent complexes and, as a result, the properties of carbon-supported nanoparticles obtained using these complexes.

Caution is required when easily flammable solvents (such as acetone) are used in the synthesis and a high temperature is applied in any of the described steps.

In the preferred embodiment, the metal reduction step in the method of the invention is carried out in the dry reduction process by subjecting the carbon substrate, onto which the metal-urea complexing agent complexes were adsorbed, to the hydrogen gas atmosphere. In this dry reduction process the sample of filtered carbon containing adsorbed metal-urea complexing agent complexes (obtained either in one step or multistep synthesis) is first placed in the stream of inert gas (preferably argon) at the temperature in the range of 20-150° C. and kept until any residual oxygen is removed, for example for about 1-3 hours.

Next, the sample is reduced in H₂/inert gas stream (gas reduction stream), preferably H₂/Ar or H₂/N. Preferably the reduction process takes 1-6 hours. Also preferably, the gas reduction stream comprises 1-10% hydrogen. Moreover, in a preferred embodiment the reduction process takes place at an elevated temperature, such as 50-200° C. In the final step gas atmosphere is switched again to the inert gas (preferably argon or nitrogen) and the sample is left to cool down to ambient temperature. After the reduction step, optionally, the sample is heat treated in the stream of an inert gas (preferably argon or nitrogen), typically at 50-350° C. for 1-6 hours. This step allows for removal of impurities or unreacted urea/urea derivatives adsorbed on the carbon support.

It should be emphasized that urea decomposes at temperatures above 190° C. (Phys. Chem. Chem. Phys., 2019, 21, 16785). Nitrogen from urea or urea decomposition products could be bound to carbon-support surface and thereby modify the surface properties of the support. It has been described in the scientific literature that nitrogen in carbon support has a beneficial effect on PGM/carbon catalysts. In particular, heating carbon support in ammonia stream leads to incorporation of nitrogen atoms in the carbon structure resulting in enhancement of catalytic activity of Pt and Pt-alloy activity and durability (Enhancement of Pt and Pt-alloy fuel cell catalyst activity and durability via nitrogen-modified carbon supports” Energy Environ. Sci., 2010, 3, 1437-1446 11439). It is possible that urea can be a similar source of nitrogen, especially at sufficiently high temperatures, when urea decomposes to ammonia and carbon dioxide, and may result in a similar structure modification. Application of carbon-supports modified by nitrogen atoms or urea-derivatives are possible routes to obtain carbon-supported metal nanoparticles with modified catalytic properties. It should be stressed here that nitrogen presence after adsorption of a complex of metal with a urea complexing agent has been observed by the inventors using X-ray Photoelectron Spectroscopy. Additionally when adsorption process is performed from an molar excess of urea as compared to metal precursor, excess of uncomplexed urea can adsorb on carbon support during adsorption phase, leading to competition between urea and complex of metal with a urea complexing agent. Thus the large stoichiometric excess of urea as compared to the metal precursor (i.e. 20:1) can lead to lower coverage of carbon by metal nanoparticles and higher nitrogen doping of the carbon support. This provides a simple method to adjust the nitrogen-to-carbon ratio of the support and metal-to-carbon ratio of the finished product.

At any stage of the reduction process, the flow rate of the inert gas or H₂/inert gas mixture is in the range of 5-30 ml/min.

The method of the invention is very versatile, as it enables a synthesis of catalysts having a wide range of metal:carbon mass-ratios. Therefore, the catalysts obtained by the method of the invention can be used in different fields. Moreover, the materials obtained by the method of the invention (i.e. carbon-supported metal nanoparticles) exhibit high activity and the nanoparticles obtained on carbon support by the method of the invention have a very small average size (down to 0.8-1.6 nm diameter range) and show uniform distribution of nanoparticle size, which results in highly developed surface area. Due to the highly developed surface area the materials obtained by the method of the invention show high activity per mass of noble metal used. Additionally it is possible that nitrogen from urea or urea derivative decomposition is introduced to the final catalyst, which can be beneficial for catalytic activity. Therefore, the method of the invention allows to use low amounts of noble metal precursor salts for synthesis of catalysts showing desired activity.

Due to the fact that the complexes of platinum group metals with urea complexing agent provide a very good coverage when adsorbed on the surface of the carbon support, the present application also provides a method of adsorption of precursors of platinum group metals on the surface of a carbon support, wherein the carbon support is immersed in a solution of complexes of platinum group metals with urea complexing agent, the urea complexing agent being selected from a group comprising urea, urea derivative, a mixture of urea with at least one urea derivative, and a mixture of at least two urea derivatives. This method is especially useful for further nanoparticle synthesis by reduction of the platinum group metal precursors on carbon support. The terms, such as “precursors”, “carbon support” and “urea complexing agent,” have the same meaning as described above in the context of the method of synthesis of carbon-supported platinum group metal or platinum group metal alloy nanoparticles according to the invention.

In the preferred embodiment, the formation of the complex of platinum group metals with urea complexing agent is carried out in the presence of the carbon support and the complexes of a platinum group metal with a urea complexing agent are adsorbed on the carbon-support directly after formation.

The present invention is also directed to the use of complexes of platinum group metals with urea complexing agent for adsorption of platinum group metal precursors on carbon support.

### BRIEF DESCRIPTION OF DRAWINGS

The subject of the invention is illustrated in a drawing, in which:

FIG. 1 presents cyclic voltammograms recorded in 0.5M H₂SO₄ for samples with different nominal Pt mass content. The voltammograms were recorded at the scan rate of 5 mV s⁻¹.

FIG. 2 presents TEM images and EDX maps for samples with different nominal Pd mass content (a) 1% Pd and 99% C and (b) 5% Pd and 95% C.

FIG. 3 presents a cyclic voltammogram recorded in 0.5M H₂SO₄ for a sample containing nominally 5% Rh and 95% C. Cyclic voltammogram of a sample containing pure carbon was added on the graph for comparison. Voltammograms were recorded at the scan rate of 5 mV s⁻¹.

FIG. 4 presents TEM images and EDX maps for a sample containing nominally 5% Rh and 95% C.

FIG. 5 presents cyclic voltammograms recorded in 0.5M H₂SO₄ for samples containing nominally 5% Pt and 95% C obtained on different carbon black supports and using different reduction temperature: (a) Ketjenblack EC300J as carbon support, and (b) Vulcan® XC-72 as carbon support. Cyclic voltammograms of samples containing 100% carbon (Ketjenblack EC300J or Vulcan® XC-72) were added on the graphs for comparison. The voltammograms were recorded at the scan rate of 5 mV s⁻¹.

FIG. 6 presents TEM images and EDX maps for samples containing nominally 5% Pt and 95% C on different C supports obtained by reduction at 100° C.: (a) Ketjenblack EC300J, and (b) Vulcan® XC-72.

FIG. 7 presents a histogram of Pt nanoparticles calculated based on an image presented on FIG. 6(b) in the 5 nm scale.

FIG. 8 presents cyclic voltammograms recorded in 0.5M H₂SO₄ for samples containing nominally 5% Pd and 95% C obtained using different amounts of carbon. The voltammograms were recorded at the scan rate of 5 mV s⁻¹.

FIG. 9 presents cyclic voltammograms recorded in 0.5M H₂SO₄ for samples containing nominally 5% Pd and 95% C obtained using urea and urea derivatives: Pd1-Pd complex with urea; Pd2-Pd complex with N,N′-dimethylurea; Pd3-Pd complex with N,N-dimethylurea; Pd4-Pd complex with methylurea; Pd5-Pd complex with trimethylurea; Pd6-Pd complex with N,N′-diethylurea. The voltammograms were recorded at the scan rate of 5 mV s⁻¹.

FIG. 10 presents cyclic voltammograms recorded in 0.5M H₂SO₄ for samples containing nominally 20% Ir and 80% C obtained using urea, N,N-dimethylurea and N,N′-dimethylurea. The voltammograms were recorded at the scan rate of 5 mV s⁻¹.

FIG. 11 presents TEM images and EDX maps for a sample containing nominally 5% Ir and 95% C. Sample obtained using (a) IrCl₄ or (b) IrCl₃ as precursor salt.

FIG. 12 presents cyclic voltammograms recorded in 0.5M H₂SO₄ for samples containing nominally 20% Ir and 80% C obtained from fresh solution (48 h) or aged solution (6 months) of IrCl₄. The voltammograms were recorded at the scan rate of 5 mV s⁻¹.

FIG. 13 presents cyclic voltammograms recorded in 0.5M H₂SO₄ for samples containing nominally 5% Ir and 95% C obtained using urea complexes synthesized in different temperatures: a) narrow potential window, and b) wide potential window. The voltammograms were recorded at the scan rate of 5 mV s⁻¹.

FIG. 14 presents cyclic voltammograms recorded in 0.5M H₂SO₄ for samples containing nominally 45% Pt and 55% C obtained in one-step synthesis using different temperatures. The voltammograms were recorded at the scan rate of 5 mV s⁻¹.

FIG. 15 presents cyclic voltammograms recorded in 0.5M H₂SO₄ for samples containing nominally 45% Pt and 55% C obtained in one-step synthesis using different synthesis times. The voltammograms were recorded at the scan rate of 5 mV s⁻¹.

FIGS. 16 and 17 presents cyclic voltammograms recorded in 0.5M H₂SO₄ for samples containing nominally 45% Pt and 55% C obtained using different Pt:urea ratios. The voltammograms were recorded at the scan rate of 5 mV s⁻¹.

FIG. 18 presents cyclic voltammograms recorded in 0.5M H₂SO₄ for samples containing nominally 20% Pt and 80% C obtained using different initial concentration of Pt and urea. The voltammograms were recorded at the scan rate of 5 mV s⁻¹.

FIG. 19 presents cyclic voltammograms recorded in 0.5M H₂SO₄ for samples containing nominally 45% Pt and 55% C obtained with or without heating during complex adsorption step, with urea:Pt ratio equal to (a) 20:1, and (b) 30:1. The voltammograms were recorded at the scan rate of 5 mV s⁻¹.

FIG. 20 presents cyclic voltammograms recorded in 0.5M H₂SO₄ for samples containing nominally 40% Pt and 60% C obtained using one-step and two-step synthesis routes. The voltammograms were recorded at the scan rate of 5 mV s⁻¹.

FIG. 21 presents cyclic voltammograms recorded in 0.5M H₂SO₄ for samples containing nominally 5% Pd and 95% C obtained using different reducing agents. The voltammograms were recorded at the scan rate of 5 mV s⁻¹.

FIG. 22 presents cyclic voltammograms recorded in 0.5M H₂SO₄ for samples containing nominally 5% Pd and 95% C obtained using different reduction temperatures during reduction with H₂/Ar. The voltammograms were recorded at the scan rate of 5 mV s⁻¹.

FIG. 23 presents TEM images for samples containing nominally 5% Pd and 95% C obtained using different reduction temperatures during reduction with H₂/Ar.

FIG. 24 presents histograms of diameters of Pd nanoparticles obtained using different reduction temperatures during reduction with H₂/Ar: (a) 50° C., (b) 100° C., and (c) 150° C. The histograms were calculated based on images presented in FIG. 23.

FIG. 25 presents cyclic voltammograms recorded in 0.5M H₂SO₄ for samples containing nominally 5% Ir and 95% C obtained using different reduction temperatures during reduction with H₂/Ar: a) narrow potential window, and b) wide potential window. The voltammograms were recorded at the scan rate of 5 mV s⁻¹.

FIG. 26 presents cyclic voltammograms recorded in 0.5M H₂SO₄ for samples containing nominally 45% Pt and 55% C obtained in synthesis using urea:Pt ratio equal to 2:1, which underwent or didn't undergo post-synthesis heat-treatment at 350° C. The voltammograms were recorded at the scan rate of 5 mV s⁻¹.

FIG. 27 presents TEM images and EDX maps for sample containing nominally 45% Pt and 55% C (a) without post-synthesis heat-treatment and (b) with post-synthesis heat-treatment.

FIG. 28 presents histograms of Pt nanoparticle diameters in samples containing nominally 45% Pt and 55% C (a) without and (b) with the post-synthesis heat-treatment at 350° C. The histograms were calculated based on images presented in FIG. 27.

FIG. 29 presents cyclic voltammograms recorded in 0.5M H₂SO₄ for samples containing nominally 45% Pt and 55% C), obtained in synthesis using urea:Pt ratio equal to (a) 2:1 or (b) 4:1, which underwent or didn't undergo post-synthesis heat-treatment at 300° C. The voltammograms were recorded at the scan rate of 5 mV s⁻¹.

FIG. 30 presents cyclic voltammograms recorded in 0.5M H₂SO₄ for samples containing nominally 5% Rh and 95% C obtained using metal precursor salt or metal-urea complex in the adsorption step. Cyclic voltammogram of a sample containing 100% carbon was added on the graph for comparison. The voltammograms were recorded at the scan rate of 5 mV s⁻¹.

FIG. 31 presents cyclic voltammograms recorded in 0.5M H₂SO₄ for samples containing nominally 20% metal and 80% C with different Pt:Ir nanoalloys: 100% Ir; 75% Ir, 25% Pt; 50% Ir, 50% Pt; 25% Ir, 75% Pt; 100% Pt. The voltammograms were recorded at the scan rate of 5 mV s⁻¹.

FIG. 32 presents TEM images of (a) 20% Pt 80% C (Vulcan®) catalyst from BASF and (b) 20% Pt 80% C (Vulcan®) sample obtained by method of the invention.

FIG. 33 presents histograms of Pt nanoparticle diameters in samples of (a) 20% Pt 80% C (Vulcan®) catalyst from BASF and (b) 20% Pt 80% C (Vulcan®) sample obtained by method of the invention. The histograms were calculated based on TEM images presented in the 10 nm scale in FIG. 32.

FIG. 34 presents TEM images of (a) 40% Pt 60% C (Vulcan®) catalyst from E-TEK and (b) 40% Pt 60% C (Vulcan®) sample obtained by method of the invention.

FIG. 35 presents histograms of Pt nanoparticle diameters in samples of (a) 40% Pt 60% C (Vulcan®) catalyst from E-TEK and (b) 40% Pt 60% C (Vulcan®) sample obtained by method of the invention. The histograms were calculated based on TEM images presented in the 10 nm scale in FIG. 34.

FIG. 36 presents: (a) mass-normalized cyclic voltammograms recorded in 0.5M H₂SO₄ for a sample containing nominally 40% Pt and 60% C (Ketjenblack®) obtained by the method of the invention and a commercial catalyst—40% Pt 60% C (Vulcan®) catalyst from E-TEK and (b) TEM images corresponding to the samples presented in the cyclic voltammograms. The voltammograms were recorded at the scan rate of 5 mV s⁻¹. The charge values written in the voltammogram plots are the total charge values corresponding to the process of desorption of a hydrogen monolayer from the platinum catalyst surface.

FIG. 37 presents cyclic voltammograms recorded in 0.5M H₂SO₄ for samples containing nominally 20% Pt and 80% C obtained using different reducing agents. The voltammograms were recorded at the scan rate of 5 mV s⁻¹.

FIG. 38 presents ionic currents determined by mass spectrometry recorded during thermal decomposition of urea complexes of iridium (III) deposited on carbon black (20% Ir and 80% C) at a heating rate of 0.6° C./min. Ionic current of m/z=17 can be attributed to ammonia, m/z=18 can be attributed to water and m/z=44 to carbon dioxide.

FIG. 39 presents the TEM images and EDX maps for samples containing 20% Ir and 80% C after Ir-urea complex adsorption, a-c) before and d) after thermal Ir-urea complex decomposition in an inert atmosphere.

### EXAMPLES

### Example 1. Synthesis of Carbon-Supported Pt Nanoparticles—Different Metal-Carbon Mass Ratio

10 ml of 0.01 mol l⁻¹ K₂PtCl₄ and 0.125 ml 2 mol l⁻¹ urea (urea:Ptratio equal to 2.5:1) were mixed and heated in a Petri dish at 90° C. until all the liquid evaporated. The precipitate was left for 5 minutes under fume hood without heating and, then, it was dissolved in 10 ml of water, so that a 0.01 mol l⁻¹ solution of a platinum-urea complex was obtained. The synthesis was repeated two times so that a total of 30 ml 0.01 mol l⁻¹ solution was obtained. The solution was left for 5 hours and, next, calculated amounts of the solution were added to ca. 50 mg samples of carbon black in order to attain the desired metal:carbon ratio in the dry-mass of the sample (1.28, 6.09 and 16.23 ml for 5, 20 and 40% nominal content of Pt, respectively). The obtained suspensions of carbon in the solution of platinum-urea complex were then heated for two hours at 90° C. under reflux. Afterwards, the suspension was filtered and washed thoroughly with water. The sample was then placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm. Presence of nitrogen after precursor adsorption and before reduction was confirmed using X-ray Photoelectron Spectroscopy. Additionally after the reduction step nitrogen was present, as determined using the same method. Nitrogen can be removed to a large excess from the final sample by washing in water ethanol solution.

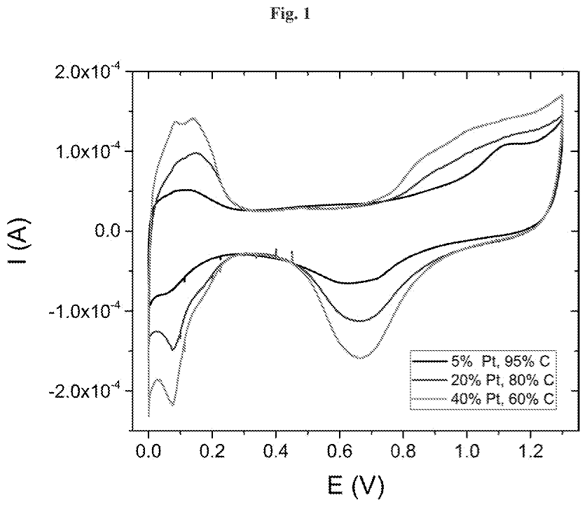

The obtained materials: carbon-Pt nanoparticles, were examined by cyclic voltammetry. Several milligrams of a synthesized material were mixed with 5% Nafion® solution (from DuPont) added in such an amount, that Nafion® constitutes ca. 32% of the dry mass of the mixture. Next, equal volume of isopropanol is added. For example, for 6.8 mg of material 80 ul of 5% Nafion (density=0.8 g cm-3) and 80 ul isopropanol were used. Next, 1 ul of the obtained suspension is dropped on a gold-disc electrode and left to dry under argon atmosphere. The obtained electrode containing the synthesized material (mixed with Nafion) deposited on a gold-disc electrode is then used as the working electrode in a three-electrode set-up for cyclic voltammetry measurements. A gold-disc electrode is also used as the counter electrode and a sulfur mercury electrode is used as the reference electrode. In all measurements 0.5 M H₂SO₄ is used as the supporting electrolyte. Before measurements the supporting solution is deaerated using argon bubbling through the solution. The examples of the recorded cyclic voltammograms are presented in FIG. 1. All potentials are given with respect to reversible hydrogen electrode.

A wide range of Pt:carbon mass-ratios can be obtained with the described method, which allows for the preparation of catalysts potentially applicable in different fields.

### Example 2. Synthesis of Carbon-Supported Pd Nanoparticles—Different Metal-Carbon Mass Ratio

10 ml of 0.01 mol l⁻¹ K₂PdCl₄ and 0.25 ml of 1 mol l⁻¹ solution of urea (urea:Pd ratio equal to 2.5:1) were mixed and heated in a Petri dish at 80° C. until all the liquid evaporated. The precipitate was dissolved in 10 ml of water and the evaporation/dissolution procedure was repeated two times. Calculated amounts of the obtained 0.01 mol l⁻¹ Pd-urea complex solution were added to ca. 50 mg samples of carbon black in order to attain the desired metal:carbon ratio in the dry mass of the sample (2.26 ml and 0.43 ml for 5% Pd 95% C and 1% Pd 99% C, respectively). The obtained suspensions of carbon in the solution of palladium-urea complex were left for 30 minutes and, afterwards, filtered and washed thoroughly with water. The sample was then placed in a tube furnace, dried under argon atmosphere at 100° C. for 4 hours and, subsequently, reduced in hydrogen-argon mixture (10% H₂, 90% Ar) at 100° C. for 4 hours and left to cool down to ambient temperature under argon atmosphere. The flow rate of the gaseous stream (argon or hydrogen-argon mixture) was 15 sccm.

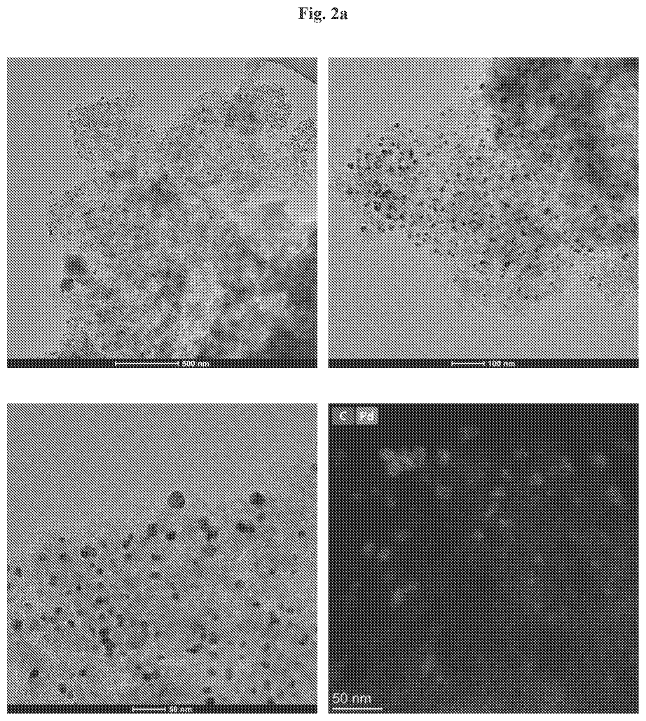

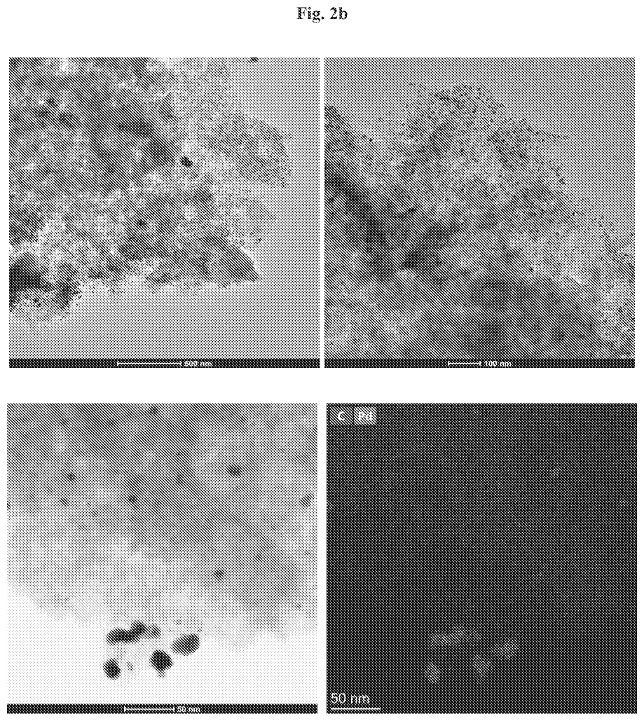

FIG. 2 (a) and (b) present TEM images and EDX maps of the obtained materials-carbon supported Pd catalysts.

### Example 3. Synthesis of Carbon-Supported Rh Nanoparticles

10 ml of 0.01 mol l⁻¹ RhCl₃ and 0.25 ml of 1 mol l⁻¹ urea (urea:Rh ratio equal to 2.5:1) were mixed and heated at 90° C. in a Petri dish until all the liquid was evaporated. The obtained precipitate was dissolved in 10 ml of water and the evaporation-dissolution procedure was repeated two times. Ca. 2.43 ml of the resulting 0.01 mol l⁻¹ solution of rhodium urea complex were added to ca. 50 mg of carbon black, in order to obtain the desired rhodium:carbon mass ratio (5% Rh, 95% C). The obtained suspension was left for ca. 5 hours and, then, filtered and washed thoroughly with water. The sample was next placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm.

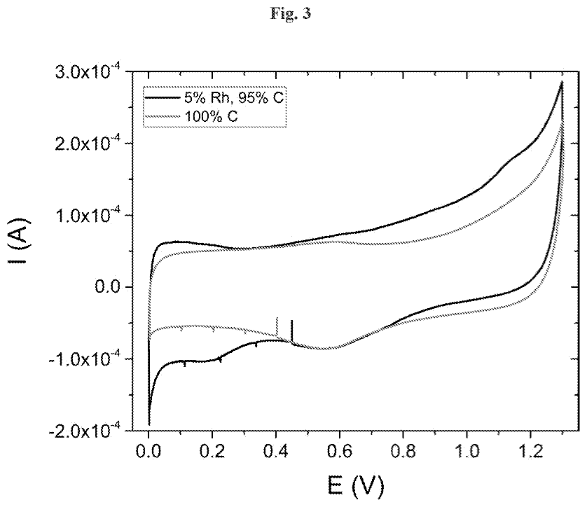

In order to assess the activity in the hydrogen adsorption-desorption process, the obtained sample was analyzed by means of cyclic voltammetry. Cyclic voltammograms of a sample containing 100% carbon were measured for comparison. The samples were prepared and measurements were recorded in the same way as described in Example 1. The examples of the recorded cyclic voltammograms are presented in FIG. 3. The obtained Rh/C catalyst shows clear activity in the hydrogen adsorption-desorption process (current peaks observed between ca. −0.3 and −0.65 V).

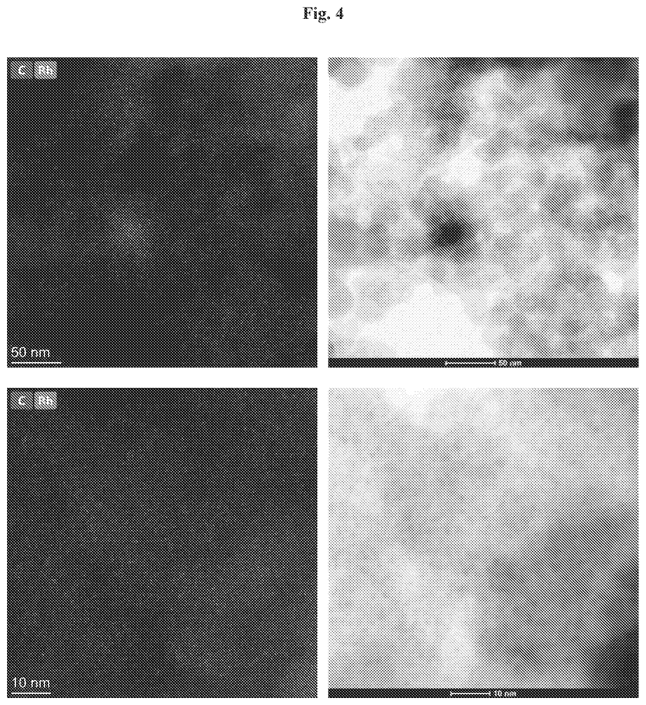

FIG. 4 presents TEM images and EDX maps of the obtained material-carbon supported Rh catalyst.

### Example 4. Synthesis of Carbon-Supported Pt Nanoparticles on Different Types of Carbon Supports

10 ml of 0.01 mol l⁻¹ K₂PtCl₄ and 0.125 ml of 2 mol l⁻¹ urea (urea:Pt ratio equal to 2.5:1) were mixed and heated in a Petri dish at 90° C. until all the liquid evaporated. The precipitate was left for 5 minutes under fume hood without heating and, then, it was dissolved in 10 ml of water, so that a 0.01 mol l⁻¹ solution of a platinum-urea complex was obtained. The solution was left for 5 hours and, next, calculated amounts of the solution were 1 added to ca. 50 mg pre-weighted carbon samples (1.26 and 1.28 ml for Ketjenblack® EC300J and Vulcan® XC-72, respectively) in order to attain the desired metal:carbon ratio in the dry-mass of the samples (5% metal, 95% carbon). The obtained suspensions were left for 1 hour, filtered and washed thoroughly with water. The samples were then placed in a tube furnace, dried under argon atmosphere at 100 or 150° C. for 4 hours and, subsequently, reduced in hydrogen argon mixture (10% H₂, 90% Ar) at 100 or 150° C. for 4 hours and left to cool down to ambient temperature under argon atmosphere. The flow rate of the gaseous stream (argon or hydrogen-argon mixture) was 15 sccm.

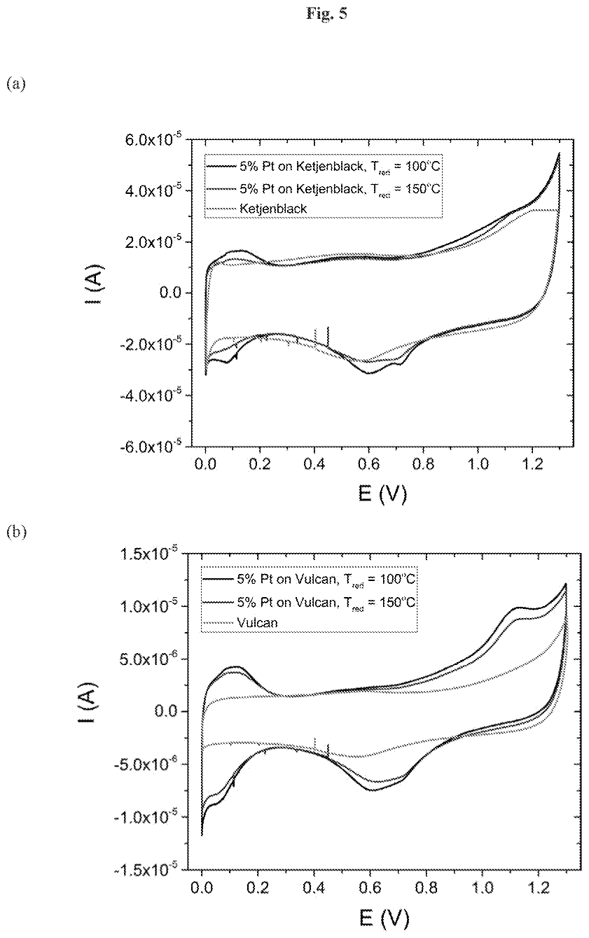

The materials obtained using different C supports and reduced at different temperatures were examined by cyclic voltammetry as described in Example 1. Examples of the recorded cyclic voltammograms are presented in FIG. 5. It can be observed that independent of the carbon-support type, a higher applied reduction temperature results in lower activity in the hydrogen adsorption-desorption region, as compared to lower reduction temperature. This can be caused by a higher probability of nanoparticle sintering at a higher reduction temperature, which should result in lower surface area and, in turn, lower activity.

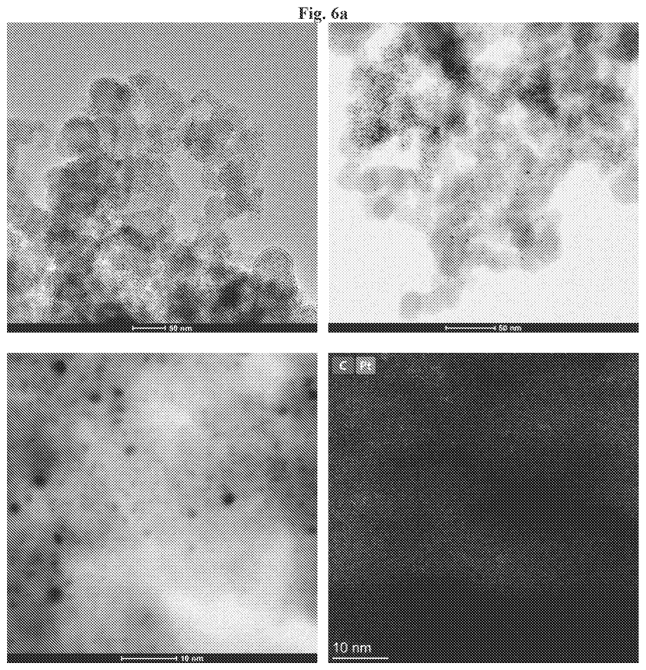

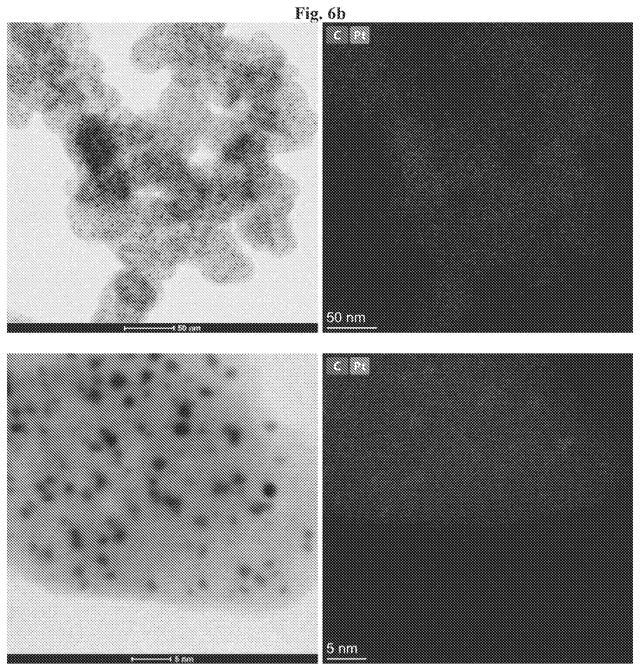

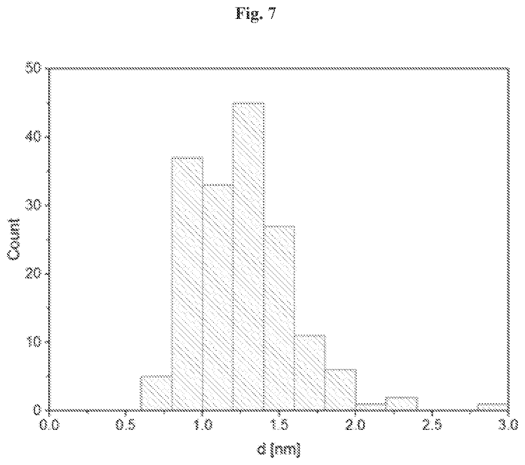

On FIG. 6 selected TEM images and EDX maps of the obtained samples are presented. Also for a sample containing nominally 5% Pt and 95% of Vulcan® XC 72 as carbon support, a histogram of nanoparticle diameter is presented in FIG. 7. This histogram was obtained based on a 5 nm scale image presented on FIG. 6(c), i.e. an image of a sample containing nominally 5% Pt and 95% C—Vulcan® XC 72 obtained with a reduction temperature of 100° C. Based on this histogram it can be clearly seen that in case of 5% Pt/Vulcan catalyst a narrow distribution of nanoparticles of very small size (most of the nanoparticles are in the 0.8-1.6 nm diameter range) can be obtained.

### Example 5. Synthesis of Carbon-Supported Pd Nanoparticles Using Different Amounts of Carbon Support

15 ml of 0.05 mol l⁻¹ K₂PdCl₄ and 1.88 ml of 1 mol l⁻¹ solution of urea were mixed and heated in a Petri dish at 80° C. until all the liquid evaporated. The precipitate was dissolved in 10 ml of water and the evaporation was repeated. Then the precipitate was dissolved in 15 ml of water. Calculated amounts of the obtained 0.05 mol l⁻¹ Pd-urea complex solution were added to pre-weighted amounts of carbon (0.45, 2.7 and 9 ml for ca. 50, 300 and 1000 mg of carbon black, respectively; the carbon samples were first dispersed in water using ultrasound bath for 5 minutes-10 mg of carbon per 1 ml of water) in order to attain the desired metal:carbon ratio in the dry mass of the sample (5% Pd, 95% C). The obtained suspensions of carbon in the solution of palladium-urea complex were left for 30 minutes and, afterwards, filtered and washed thoroughly with water. The sample was then placed in a tube furnace, dried under argon atmosphere at 100° C. for 4 hours and, subsequently, reduced in hydrogen-argon mixture (10% H₂, 90% Ar) at 100° C. for 4 hours and left to cool down to ambient temperature under argon atmosphere. The flow rate of the gaseous stream (argon or hydrogen-argon mixture) was 15 sccm.

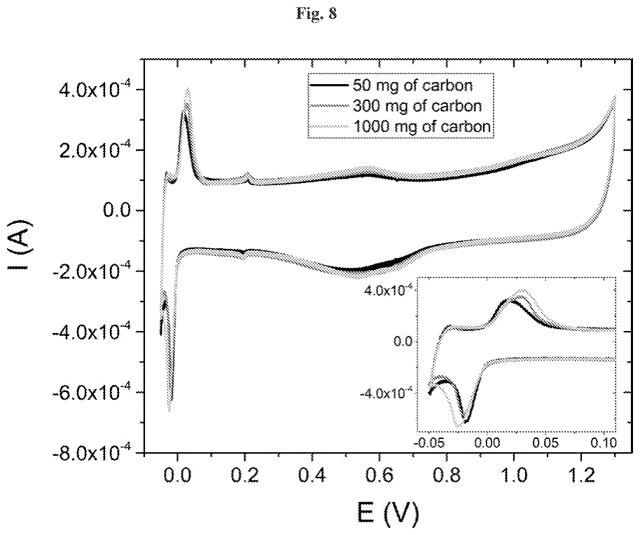

The obtained samples were investigated using cyclic voltammetry as described in Example 1. The examples of recorded voltammograms are presented in FIG. 8. Only small differences in the cyclic voltammograms can be observed between the samples prepared using different amounts of carbon-support. This shows that the method of synthesis according to the invention can be easily used for different amounts of regents, resulting in scalability of this synthesis method.

### Example 6. Synthesis of Carbon-Supported Pd Nanoparticles Using Different Urea Derivatives

10 ml of 0.01 mol l⁻¹ K₂PdCl₄ and 0.25 ml of 1 mol l⁻¹ solution of urea or urea derivative (methylurea, N,N-dimethylurea, N,N′-dimethylurea, trimethylurea, N,N′-diethylurea) were mixed and heated in a Petri dish at 80° C. until all the liquid evaporated. The precipitate was dissolved in 10 ml of water and the evaporation/dissolution procedure was repeated. 2.26 ml of each of the obtained 0.01 mol l⁻¹ Pd-complex solutions were added to pre-weighted ca. 50 mg samples of carbon black in order to attain the desired metal:carbon ratio in the dry-mass of the sample (5% Pd, 95% C). The obtained suspensions were left for 30 minutes and, afterwards, filtered and washed thoroughly with water. The samples were then placed in a tube furnace, dried under argon atmosphere at 100° C. for 4 hours and, subsequently, reduced in hydrogen argon mixture (10% H₂, 90% Ar) at 100° C. for 4 hours and left to cool down to ambient temperature under argon atmosphere. The flow rate of the gaseous stream (argon or hydrogen-argon mixture) was 15 sccm.

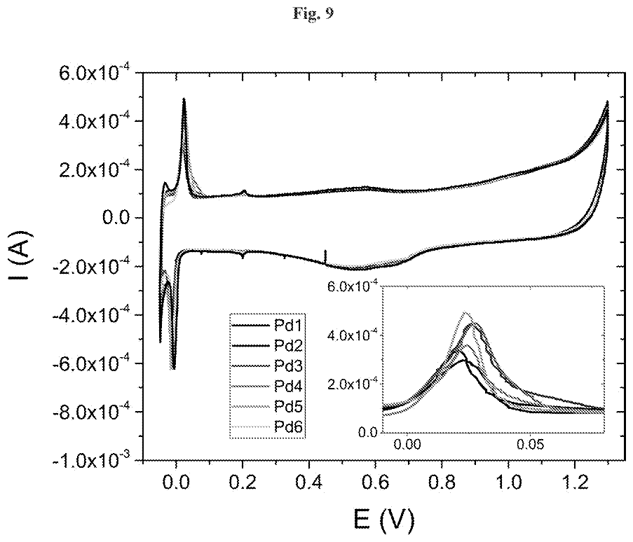

The obtained samples were investigated using cyclic voltammetry as described in Example 1. The examples of recorded voltammograms are presented in FIG. 9. The observed activity of the materials in the hydrogen absorption-desorption process (current peaks between ca. −0.6 and −0.7V) was of a similar order of magnitude for all the prepared samples, however samples prepared using urea, methylurea and trimethylurea showed the best performance (i.e. the highest charge associated with the absorption-desorption processes).

### Example 7. Synthesis of Carbon-Supported Ir Nanoparticles Using Different Urea Derivatives

The following solutions were prepared:
a) 10 ml of 0.01 mol l⁻¹ IrCl₄ was added to 0.25 ml of 1 mol l⁻¹ urea (urea:Ir ratio equal to 2.5:1),
b) 10 ml of 0.01 mol l⁻¹ IrCl₄ was added to 0.25 ml of 1 mol l⁻¹ N,N-dimethylurea (N,N dimethylurea:Ir ratio equal to 2.5:1), and
c) 10 ml of 0.01 mol l⁻¹ IrCl₄ was added to 0.25 ml of 1 mol l⁻¹ N,N′-dimethylurea (N,N′dimethylurea:Ir ratio equal to 2.5:1).

The solutions were heated at 80° C. under reflux for 1.5 hours. Next, 3.17 ml of each of the solutions were added to pre-weighted ca. 25 mg samples of carbon black in order to attain the desired iridium:carbon ratio in the dry-mass of the sample (20% Ir, 80% C). The obtained suspensions were left for ca. 15 hours and, then, filtered and washed thoroughly with water. The samples were then placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm.

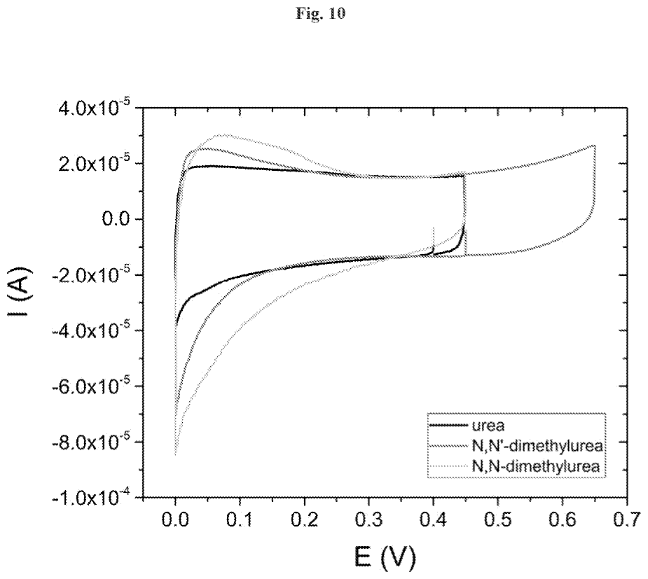

The obtained samples were investigated using cyclic voltammetry as described in Example 1. The examples of recorded voltammograms are presented in FIG. 10. In case of carbon-supported Ir nanoparticles, a significantly higher activity in the hydrogen adsorption-desorption process (ca. between −0.3 and 0.65 V) was observed for the samples for which urea derivatives (N,N-dimethylurea and N,N′-dimethylurea) were used in the synthesis instead of urea.

### Example 8. Synthesis of Carbon-Supported Ir Nanoparticles Using Different Precursor Salts

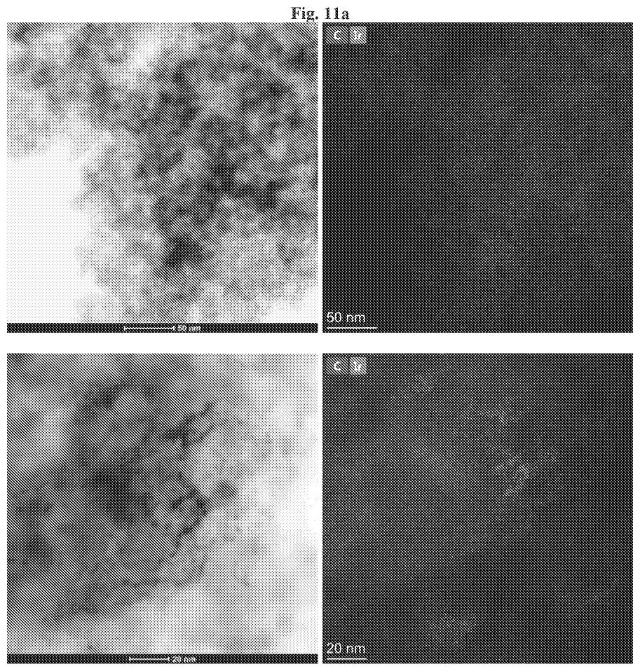

Carbon supported Ir nanoparticles were obtained as described above using IrCl₃ and IrCl₄ as precursor salts for urea complex synthesis. On FIG. 11 selected TEM images and EDX maps of the obtained samples are presented. No difference was observed in the obtained materials even though different salts were used as starting reagents in the synthesis.

### Example 9. Synthesis of Carbon-Supported Ir Nanoparticles—Influence of Hydrolysis of Precursor Salt

10 ml of 0.01 mol l⁻¹ IrCl₄ (a solution 48 hours or 6 months after preparation) and 0.25 ml of 1 mol l⁻¹ N,N-dimethylurea (N,N-dimethylurea:Ir ratio equal to 2.5:1) were mixed and heated at 80° C. under reflux for 5 hours. Next, 3.17 ml of each of the obtained Ir complex solutions were added to pre-weighted ca. 25 mg samples of carbon black in order to attain the desired metal:carbon ratio in the dry-mass of the sample (20% Ir, 80% C). The obtained suspensions were left for ca. 15 hours and, then, filtered and washed thoroughly with water. The samples were then placed in a tube furnace, dried under argon atmosphere at 150° C. for 4 hours and, subsequently, reduced in hydrogen-argon mixture (10% H2, 90% Ar) at 150° C. for 4 hours and left to cool down to ambient temperature under argon atmosphere. The flow rate of the gaseous stream (argon or hydrogen-argon mixture) was 15 sccm.

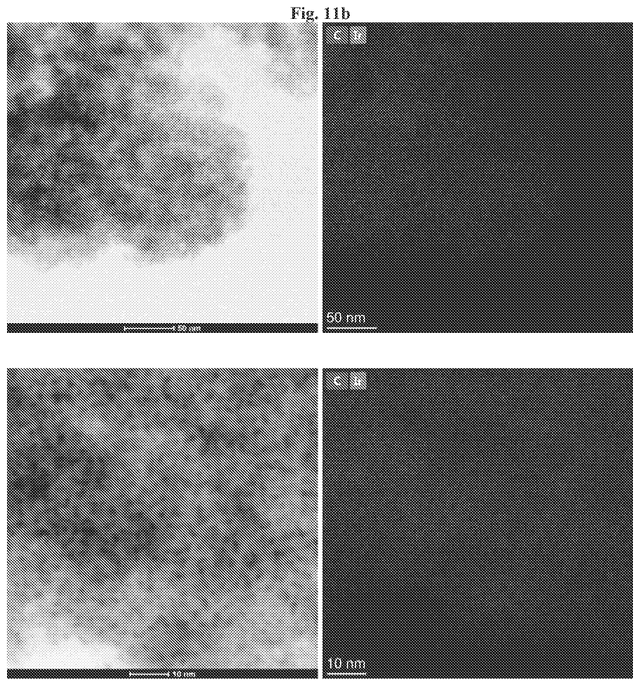

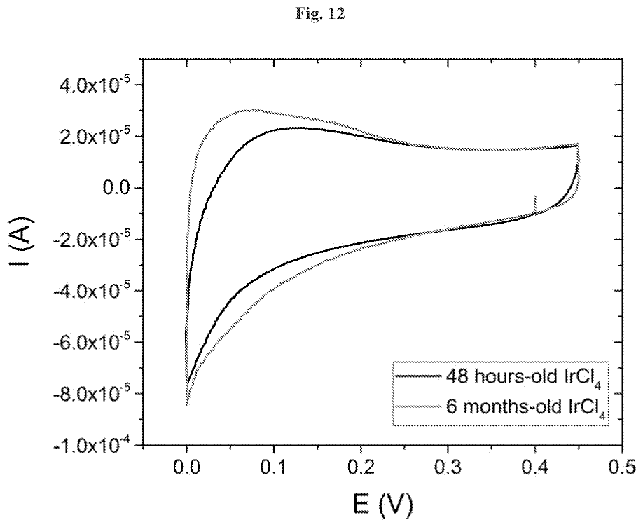

The obtained samples were investigated using cyclic voltammetry as described in Example 1. The examples of recorded voltammograms are presented in FIG. 12. In the described example a beneficial role of IrCl₄ hydrolysis can be seen. Most probably the hydrolysis process results in creation of mixed chloride- and hydroxy-complexes of iridium, which influences the type of Ir-complexes formed with urea derivatives and in turn the activity of the obtained final samples.

### Example 10. Synthesis of Carbon-Supported Ir Nanoparticles—Influence of Complex Synthesis Temperature

Three solutions consisting of 10 ml of 0.01 mol l⁻¹ IrCl₄ and 0.25 ml of 1 mol l⁻¹ N,N′-dimethylurea (N,N′-dimethylurea:Ir ratio equal to 2.5:1) were prepared. The solutions were heated under reflux at 35, 55 or 80° C. for 5, 3 and 1.5 hours, respectively. Next, 1.28 ml of each of the solutions were added to pre-weighted ca. 50 mg samples of carbon black in order to attain the desired iridium:carbon ratio in the dry-mass of the sample (5% Ir, 95% C). The obtained suspensions were left for ca. 15 hours and, then, filtered and washed thoroughly with water. The samples were then placed in a tube furnace, dried under argon atmosphere at 100° C. for 4 hours and, subsequently, reduced in hydrogen-argon mixture (10% H₂, 90% Ar) at 100° C. for 4 hours and left to cool down to ambient temperature under argon atmosphere. The flow rate of the gaseous stream (argon or hydrogen-argon mixture) was 15 sccm.

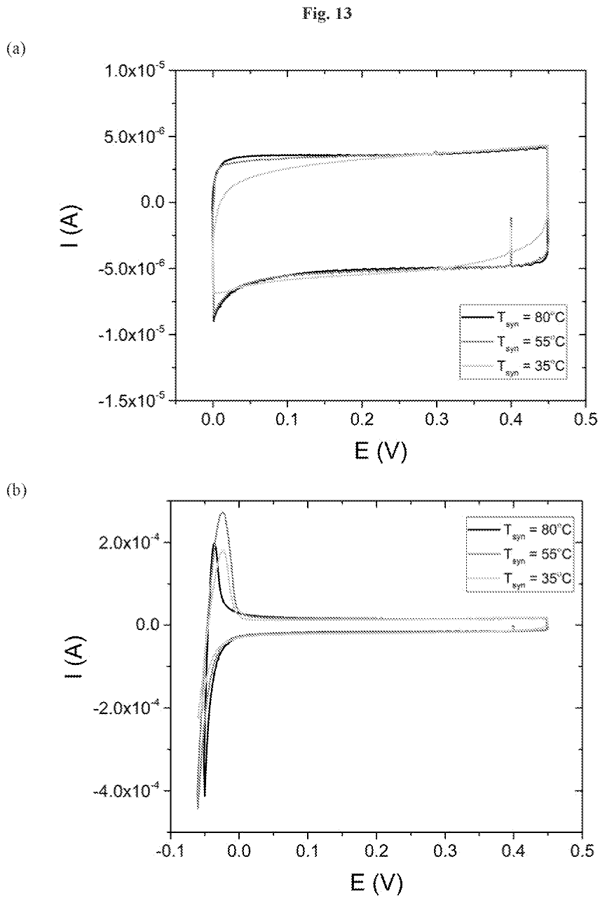

The obtained samples were investigated using cyclic voltammetry as described in Example 1. The examples of recorded voltammograms are presented in FIG. 13. Due to no clear distinction between hydrogen adsorption and hydrogen evolution regions expected on cyclic volammograms of Ir in H₂SO₄, it is hard to assess the influence of synthesis temperature and time on catalyst activity. The presence of the current peaks is indicative of presence of Ir nanoparticles. Therefore it can be concluded that Ir nanoparticles on carbon support can be obtained in a wide range of temperatures in Ir-complex synthesis.

### Example 11. One-Step Synthesis of Carbon-Supported Pt Nanoparticles—Influence of Complex Synthesis Temperature

Two samples were prepared where 15.1 ml of 0.01 mol l⁻¹ K₂PtCl₄ and 0.302 ml of 2 mol l⁻¹ urea (urea:Pt ratio equal to 4:1) were added to ca. 40 mg of carbon black, giving nominal content of 45% Pt and 55% C in the dry mass, and heated at 90 or 100° C. under reflux for 220 minutes. Next, the obtained suspensions were filtered and washed thoroughly with water. The samples were then placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm.

The obtained samples were investigated using cyclic voltammetry as described in Example 1. The examples of recorded voltammograms are presented in FIG. 14. It can be observed that a significantly higher activity of hydrogen adsorption-desorption process (between ca. 0.3 and −0.65 V) is observed for the sample obtained using a higher temperature during adsorption process.

### Example 12. One-Step Synthesis of Carbon-Supported Pt Nanoparticles—Influence of Synthesis Time

Two samples were prepared where 18.9 ml of 0.01 mol l⁻¹ K₂PtCl₄ and 0.199 ml of 2 mol l⁻¹ urea (urea:Pt ratio equal to 2.1:1) were added to ca. 50 mg of carbon black, giving nominal content of 45% Pt and 55% C in the dry mass, and heated at 100° C. under reflux for 120 or 220 minutes. Next, the obtained suspensions were filtered and washed thoroughly with water. The samples were then placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm.

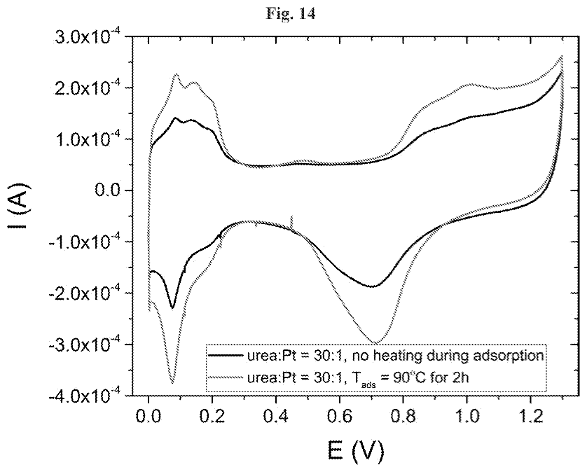

The obtained samples were investigated using cyclic voltammetry as described in Example 1. The examples of recorded voltammograms are presented in FIG. 15. No difference in activity is observed between the samples prepared in a synthesis with shorter (120 min) and longer (220 minutes) heating time during adsorption.

### Example 13. One-Step Synthesis of Carbon-Supported Pt Nanoparticles—Influence of Pt:Urea Ratio

Two samples were prepared, where 18.9 ml of 0.01 mol l⁻¹ K₂PtCl₄ and 0.199 ml of 2 mol l⁻¹ urea (urea:Pt ratio equal to 2.1:1) or 0.378 ml of 2 mol l⁻¹ urea (Pt:urea ratio equal to 4:1) were added to ca. 50 mg of carbon black, giving nominal content of 45% Pt and 55% C in the dry mass, and heated at 100° C. under reflux for 220 minutes. Next, the obtained suspensions were filtered and washed thoroughly with water. The samples were then placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm.

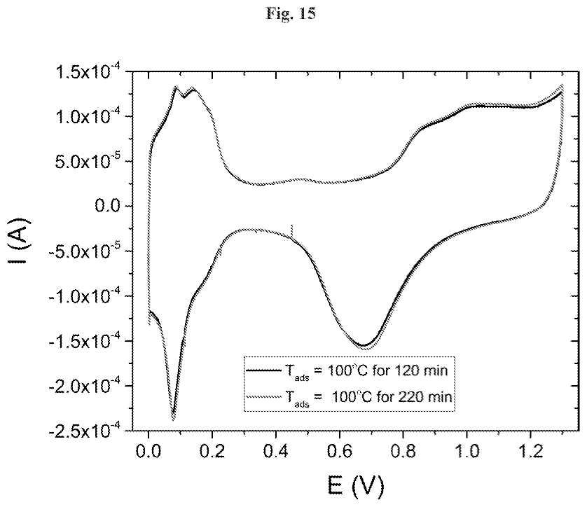

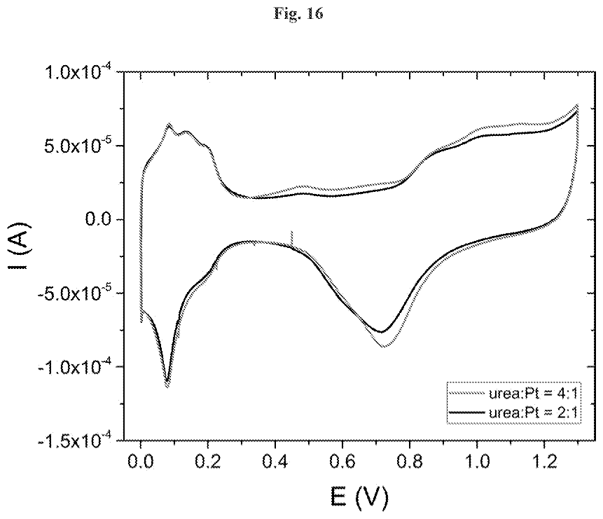

The obtained samples were investigated using cyclic voltammetry as described in Example 1. The examples of recorded voltammograms are presented in FIG. 16. Differences between the samples obtained using both ratios of urea:Pt are negligible. It shows that even a very small ratio, such as 2:1, can be used to obtain catalysts with high activity.

### Example 14. Synthesis of Carbon-Supported Pt Nanoparticles—Influence of Pt:Urea Ratio

Several solutions were prepared:
a) 0.6 ml of 2 mol l⁻¹ urea was added to 20 ml of 0.01 mol l⁻¹ K₂PtCl₄ and (urea:Pt ratio equal to 6:1)
b) 1 ml of 2 mol l⁻¹ urea was added to 20 ml of 0.01 mol l⁻¹ K₂PtCl₄ and (urea:Pt ratio equal to 10:1)
c) 2 ml of 2 mol l⁻¹ urea was added to 20 ml of 0.01 mol l⁻¹ K₂PtCl₄ and (urea:Pt ratio equal to 20:1)
d) 3 ml of 2 mol l⁻¹ urea was added to 20 ml of 0.01 mol l⁻¹ K₂PtCl₄ and (urea:Pt ratio equal to 30:1)

Each of the solutions was heated at 80° C. under reflux for one hour. Next, calculated amounts of the solutions (10.05, 10.26 and 10.71 ml of the solutions prepared in steps a), b) and c), respectively) were added to ca. 25 mg pre-weighted samples of carbon black in order to attain the desired metal:carbon ratio in the dry-mass of the samples (45% Pt, 55% C). The obtained suspensions of carbon in the solution of platinum-urea complex were then heated for two hours at 100° C. under reflux. Afterwards, the suspensions were filtered and washed thoroughly with water. The samples were then placed in a tube furnace, dried under argon atmosphere at 100° C. for 4 hours and, subsequently, reduced in hydrogen-argon mixture (10% H₂, 90% Ar) at 100° C. for 4 hours and left to cool down to ambient temperature under argon atmosphere. The flow rate of the gaseous stream (argon or hydrogen-argon mixture) was 15 sccm.

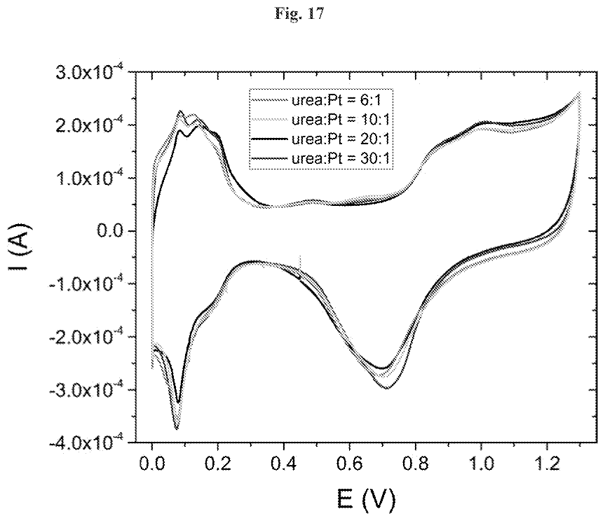

The obtained samples were investigated using cyclic voltammetry as described in Example 1. The examples of recorded voltammograms are presented in FIG. 17. Performance of all the samples was similar, however it was the best at the smallest and the highest stoichiometric ratio of urea:Pt (6:1 and 30:1). This most probably indicates that more than one effect is influenced by urea:Pt stoichiometric ratio, for example: 1) the influence of the urea:Pt ratio on the type of complex formed, 2) urea adsorption on carbon which may occupy free sites, making them inaccessible for the metal.

### Example 15. Synthesis of Carbon-Supported Pt Nanoparticles—Different Initial Concentrations of Metal Precursor and Urea at a Constant Pt:Urea Ratio

Solutions of 0.1 mol l⁻¹ K₂PtCl₄, 2 mol l⁻¹ urea and water were mixed in different amounts:
a) 5 ml of 0.1 mol l⁻¹ K₂PtCl₄, 0.625 ml of 2 mol l⁻¹ urea and 4.375 ml of water
b) 2 ml of 0.1 mol l⁻¹ K₂PtCl₄, 0.25 ml of 2 mol l⁻¹ urea and 7.75 ml of water
c) 0.5 ml of 0.1 mol l⁻¹ K₂PtCl₄, 0.063 ml of 2 mol l⁻¹ urea and 9.437 ml of water

Each of the mixtures was heated in a Petri dish at 90° C. until all the liquid evaporated. The precipitates were left for 5 minutes under fume hood without heating and, then, they were dissolved in such amount of waters, that a 0.025 mol l⁻¹ solution of a platinum-urea complex were obtained (20, 8 and 2 ml of H₂O for a), b) and c), respectively). The solutions were left for 4 hours and, next, 1.95 ml of each of the obtained Pt-urea complex solutions were added to ca. 40 mg samples of carbon black in order to attain the desired metal:carbon ratio (20% Pt, 80% C) in the dry-mass of the sample. The obtained suspensions of carbon in the solution of platinum-urea complex were then heated for two hours at 90° C. under reflux. Afterwards, the suspensions were filtered and washed thoroughly with water. The samples (containing platinum-urea complex adsorbed on carbon) were then placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm.

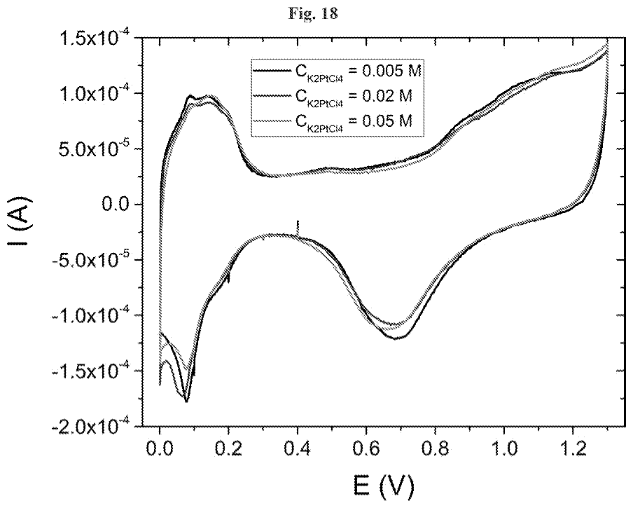

The obtained samples were investigated using cyclic voltammetry as described in Example 1. The examples of recorded voltammograms are presented in FIG. 18.

Similar activity is observed for the carbon supported Pt nanoparticles obtained from the precursor solutions of different concentration (with the highest concentration used close to the maximum concentration possible to obtain for K₂PtCl₄ precursor salt).

### Example 16. Synthesis of Carbon-Supported Pt Nanoparticles—Influence of Temperature on Urea Pt Complex Adsorption on the Carbon Support

Two solutions were prepared:
a) 2 ml of 2 mol l⁻¹ urea was added to 20 ml of 0.01 mol l⁻¹ K₂PtCl₄ and (urea:Pt ratio equal to 20:1)
b) 3 ml of 2 mol l⁻¹ urea was added to 20 ml of 0.01 mol l⁻¹ K₂PtCl₄ and (urea:Pt ratio equal to 30:1)

The solutions were then heated at 80° C. under reflux for one hour. Next, calculated amounts (10.71 ml and 11.21 ml of solutions obtained in steps a) and b), respectively) were added to two pre-weighted carbon black samples (ca. 25 mg) in order to attain the desired metal:carbon ratio in the dry-mass of the samples (45% Pt, 55% C). One of the obtained suspensions of carbon was then heated for two hours at 100° C. under reflux. Two other samples were prepared in the same way using the solution prepared in step b) and ca. 25 mg of carbon black.

Afterwards, the suspensions were filtered and washed thoroughly with water. The samples were then placed in a tube furnace, dried under argon atmosphere at 100° C. for 4 hours and, subsequently, reduced in hydrogen-argon mixture (10% H₂, 90% Ar) at 100° C. for 4 hours and left to cool down to ambient temperature under argon atmosphere. The flow rate of the gaseous stream (argon or hydrogen-argon mixture) was 15 sccm.

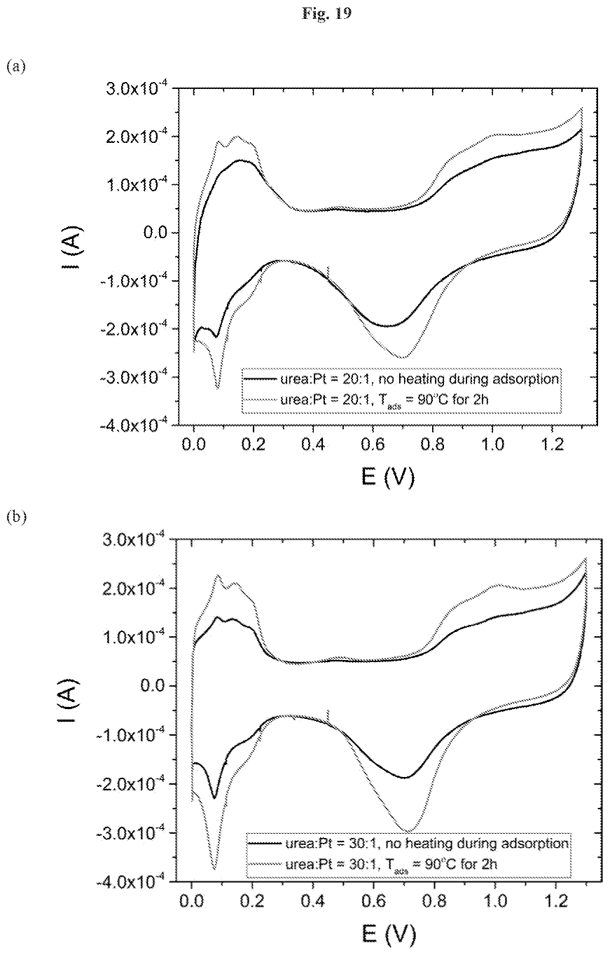

The obtained samples were investigated using cyclic voltammetry as described in Example 1. The examples of recorded voltammograms are presented in FIG. 19. A beneficial effect of heating the sample during adsorption on catalytic activity of the final samples can be observed.

### Example 17. Synthesis of Carbon-Supported Pt Nanoparticles—Comparison of One-Step and Multi-Step Synthesis Route

### One-Step Synthesis of Platinum-Urea Complex Adsorbed on Carbon

18.9 ml of 0.01 mol l⁻¹ K₂PtCl₄ and 0.236 ml of 2 mol l⁻¹ urea (urea:Pt ratio equal to 2.5:1) were added to 50 mg of carbon black, giving a sample with nominal content of 40% Pt and 60% C in the dry mass, and heated at 100° C. under reflux for 3 hours.

### Multistep Synthesis of Platinum-Urea Complex Adsorbed on Carbon

10 ml of 0.02 mol l⁻¹ K₂PtCl₄ and 0.25 ml of 2 mol l⁻¹ urea (urea:Pt ratio equal to 2.5:1) were mixed and then heated at 90° C. until all the liquid evaporated. The obtained precipitate was left for five minutes and then dissolved in 20 ml of water. The obtained solution was left for 4 hours and then 15.89 ml of it was added to ca. 50 mg of carbon black, giving a sample with nominal content of 40% Pt and 60% C in the dry mass.

The suspensions obtained in both routes were filtered and washed thoroughly with water. The samples were then placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm.

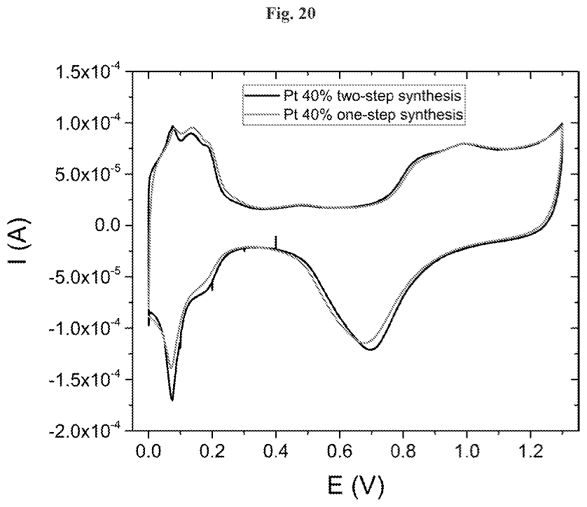

The obtained samples were investigated using cyclic voltammetry as described in Example 1. The examples of recorded voltammograms are presented in FIG. 20. Carbon-supported Pt nanoparticles obtained with different routes show similar activity. A more convenient method can be used for synthesis.

### Example 18. Synthesis of Carbon-Supported Pd Nanoparticles Using Different Reducing Agents

10 ml of 0.01 mol l⁻¹ K₂PdCl₄ and 0.25 ml of 1 mol l⁻¹ solution of urea were mixed and heated in a Petri dish at 80° C. until all the liquid evaporated. The precipitate was dissolved in 10 ml of water and the evaporation/dissolution procedure was repeated two times. 1.35 ml of the obtained solution were added to three ca. 30 mg samples of carbon black in order to attain the desired metal:carbon ratio in the dry-mass of the sample (5% Pd, 95% C). The obtained suspensions of carbon in the solution of palladium-urea complex were left for 30 minutes and, afterwards, filtered and washed thoroughly with water. Next the samples were reduced in one of the following ways:
The sample was dried under argon atmosphere at 100° C. for 4 hours and, subsequently, reduced in hydrogen-argon mixture (10% H₂, 90% Ar) at 100° C. for 4 hours and left to cool down to ambient temperature under argon atmosphere. The flow rate of the gaseous stream (argon or hydrogen-argon mixture) was 15 sccm.
1.3 ml of 0.4% NaBH4 solution in 0.02M NaOH were added and the sample was left at ambient temperature for one hour (NaBH₄:Pd ratio equal to ca. 10:1).
1.35 ml of 0.1 M citric acid was added and the sample was heated at 60° C. under reflux for one hour (citric acid:Pd ratio equal to ca. 10:1).
1.35 ml of 0.1 M L-ascorbic acid was added and the sample was heated at 60° C. under reflux for one hour (L-ascorbic acid:Pd ratio equal to ca. 10:1).

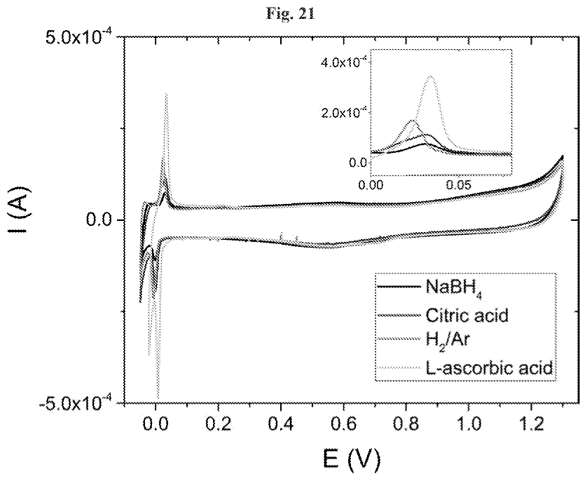

The obtained samples were investigated using cyclic voltammetry as described in Example 1. The examples of recorded voltammograms are presented in FIG. 21. Reduction process carried out using L-ascorbic acid results in a material with the best catalytic properties. Reduction with H₂ or citric acid is less beneficial than with L-ascorbic acid, whereas reduction with NaBH₄ results in the worst catalyst performance.

### Example 19. Synthesis of Carbon-Supported Pd Nanoparticles Using Hydrogen as a Reducing Agent and Different Reduction Temperatures

10 ml of 0.01 mol l⁻¹ K₂PdCl₄ and 0.25 ml of 1 mol l⁻¹ solution of urea were mixed and heated in a Petri dish at 80° C. until all the liquid evaporated. The precipitate was dissolved in 10 ml of water and the evaporation/dissolution procedure was repeated two times. 2.26 ml of the obtained solution were added to pre-weighted amounts of carbon (ca. 50 mg of carbon black) in order to attain the desired metal:carbon ratio in the dry-mass of the sample (5% Pd, 95% C). The obtained suspensions of carbon in the solution of palladium-urea complex were left for 30 minutes and, afterwards, filtered and washed thoroughly with water. The sample was then placed in a tube furnace, dried under argon atmosphere at 100° C. for 4 hours and, subsequently, reduced in hydrogen-argon mixture (10% H₂, 90% Ar) at 50, 100 or 150° C. for 4 hours and left to cool down to ambient temperature under argon atmosphere. The flow rate of the gaseous stream (argon or hydrogen-argon mixture) was 15 sccm.

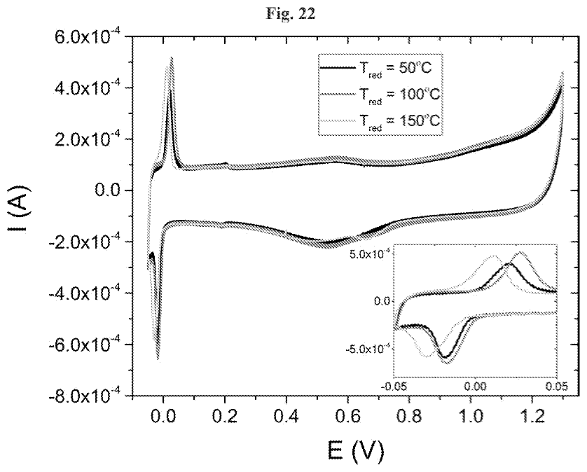

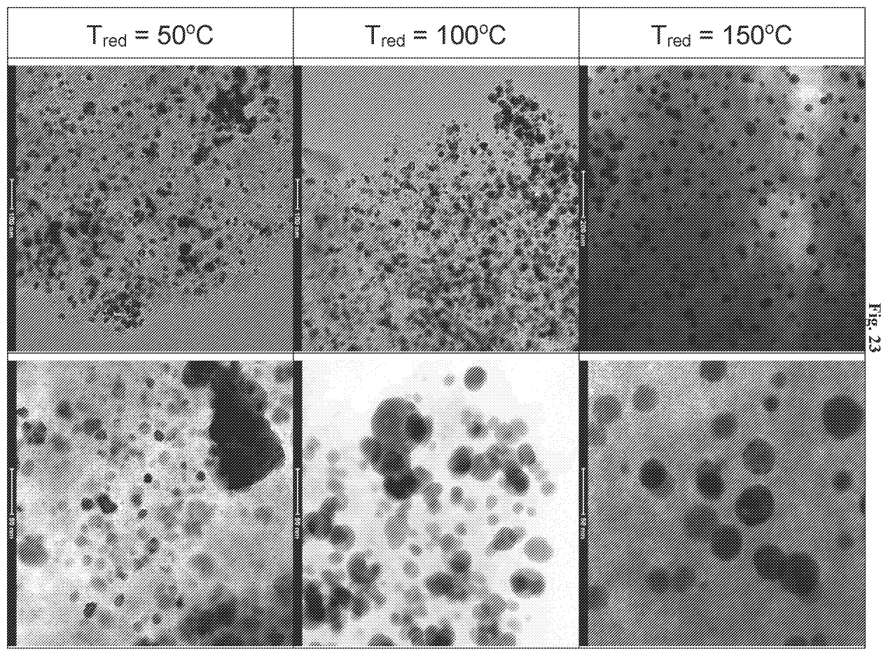

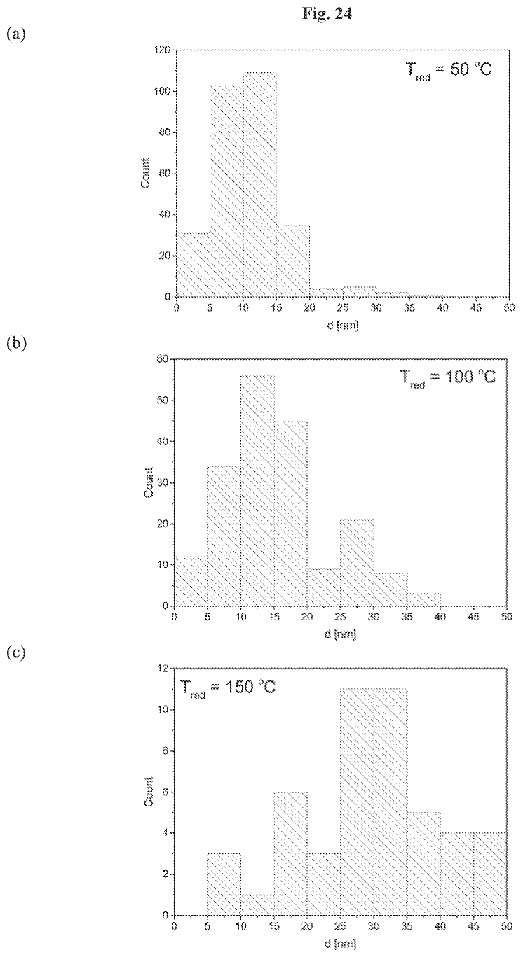

The obtained samples were investigated using cyclic voltammetry as described in Example 1. The examples of recorded voltammograms are presented in FIG. 22. Selected TEM images of the obtained samples and corresponding histograms of nanoparticle diameters are presented on FIGS. 23 and 24, respectively.

It can be observed that when reduction temperature is increased the distribution of nanoparticle diameters shifts towards higher values. This is most probably indicative of intensified nanoparticle sintering at higher temperatures. This is, however, not reflected in the obtained CVs, where the most active sample was the ones reduced at 100° C. This shows that sintering is not the only process possibly influenced by reduction temperature.

### Example 20. Synthesis of Carbon-Supported Ir Nanoparticles Using Hydrogen as a Reducing Agent and Different Reduction Temperatures

10 ml of 0.01 mol l⁻¹ IrCl₄ and 0.25 ml of 1 mol l⁻¹ N,N′-dimethylurea (N,N′-dimethylurea:Ir ratio equal to 2.5:1) were mixed. The solutions was heated under reflux for 1.5 hour at 80° C. Next, 1.28 ml of the solution were added to ca. 50 mg samples of carbon black in order to attain the desired iridium:carbon ratio in the dry-mass of the sample (5% Ir, 95% C). The obtained suspensions were left for ca. 15 hours and, then, filtered and washed thoroughly with water. The samples were then placed in a tube furnace, dried under argon atmosphere at 100° C. for 4 hours and, subsequently, reduced in hydrogen-argon mixture (10% H₂, 90% Ar) at 100 or 150° C. for 4 hours and left to cool down to ambient temperature under argon atmosphere. The flow rate of the gaseous stream (argon or hydrogen-argon mixture) was 15 sccm.

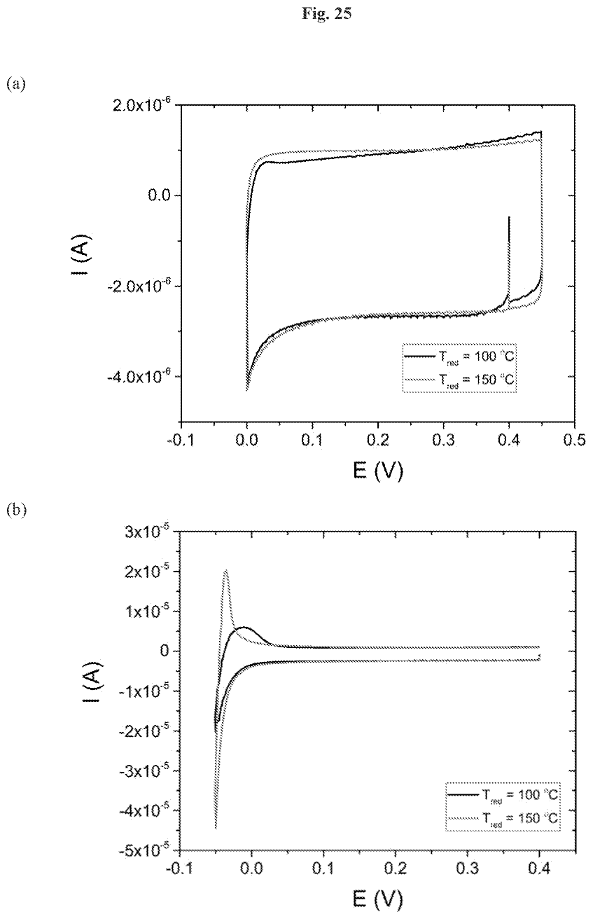

The obtained samples were investigated using cyclic voltammetry as described in Example 1. The examples of recorded voltammograms are presented in FIG. 25. In case of carbon-supported Ir nanoparticles a higher reduction temperature results in higher activity of the materials (higher current associated with hydrogen evolution process between ca. −0.6 and −0.7 V).

### Example 21. Influence of Temperature Post-Treatment on Carbon-Supported Pt Nanoparticles Obtained in One-Step Synthesis

Several samples were prepared:
a) 15.1 ml of 0.01 mol l⁻¹ K₂PtCl₄ and 0.159 ml of 2 mol l⁻¹ urea (urea:Pt ratio equal to 2.1:1) were added to 40 mg of carbon black.
b) 15.1 ml of 0.01 mol l⁻¹ K₂PtCl₄ and 0.159 ml of 2 mol l⁻¹ urea (urea:Pt ratio equal to 2.1:1) were added to 40 mg of carbon black.
c) 15.1 ml of 0.01 mol l⁻¹ K₂PtCl₄ and 0.302 ml of 2 mol l⁻¹ urea (urea:Pt ratio equal to 4:1) were added to 40 mg of carbon black.

In each sample the nominal mass content of Pt was 45% in the dry mass. Each of the samples was heated at 100° C. under reflux for 220 minutes. Next, the obtained suspensions were filtered and washed thoroughly with water. The samples were then placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm. Afterwards, each of the obtained samples was divided into two parts, where one part was subjected to heating at 300 or 350° C. for 4 hours under argon atmosphere.

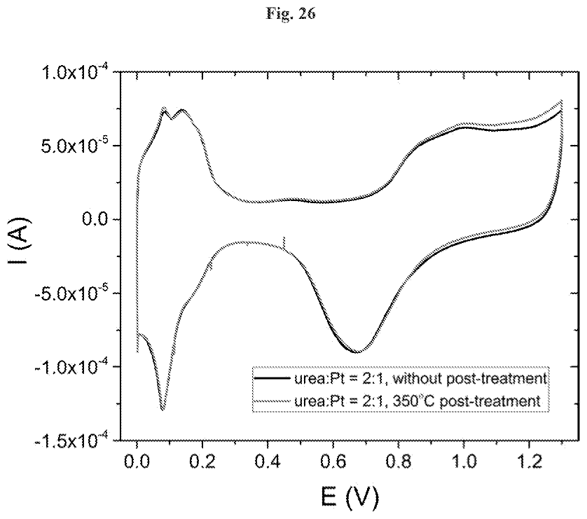

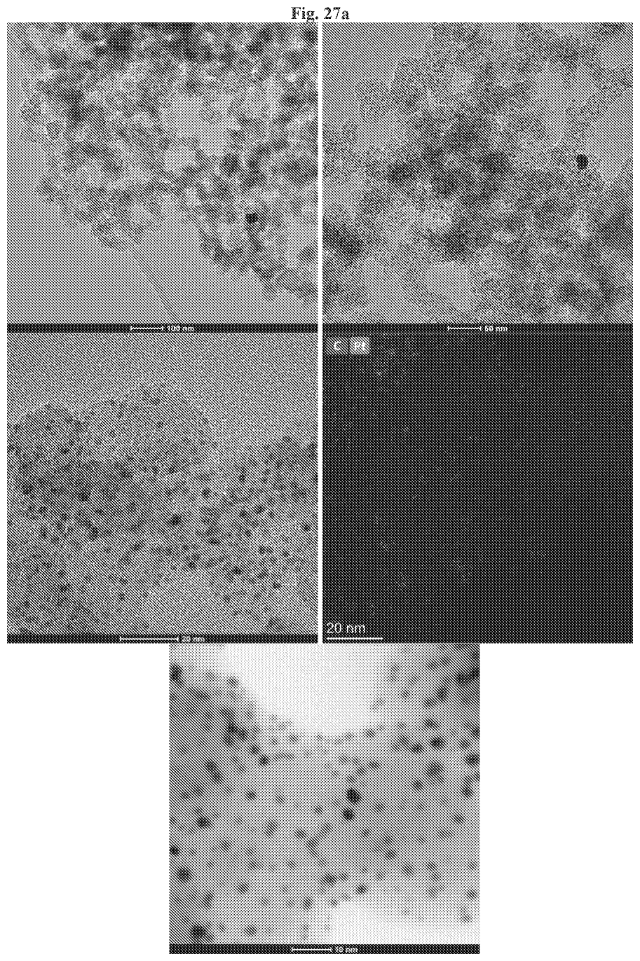

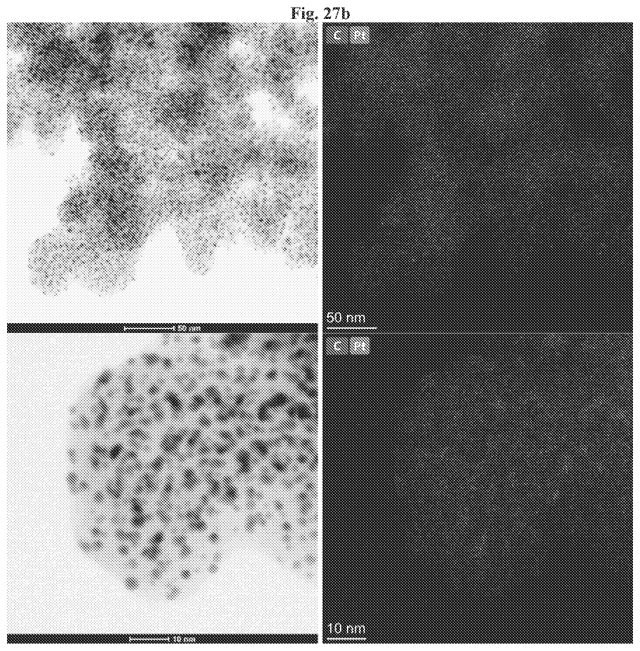

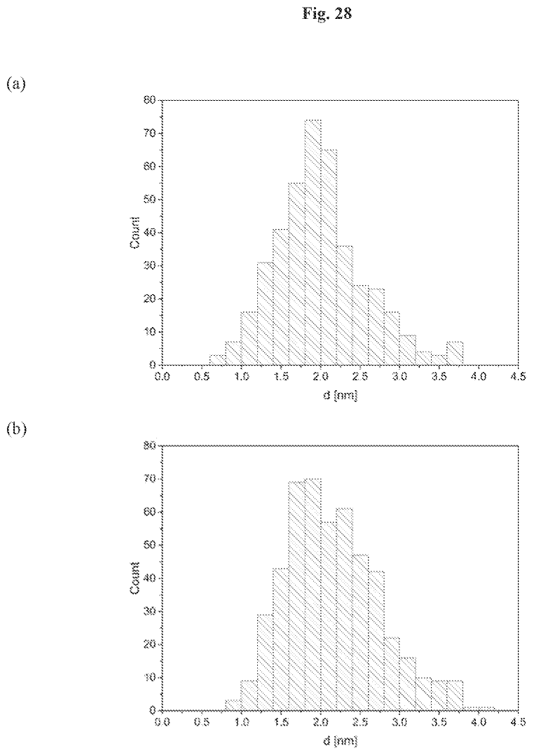

The samples both before and after the temperature treatment were investigated using cyclic voltammetry as described in Example 1. The examples of voltammograms recorded for samples containing nominally 45% Pt and 55% C (Ketjenblack), obtained in synthesis using urea:Ptratio equal to 2.1:1, are presented in FIG. 26 (heat treatment at 350° C.). Selected TEM images for these samples before and after temperature treatment and corresponding histograms of nanoparticle diameters are presented on FIGS. 27 and 28, respectively. The examples of voltammograms recorded for samples containing nominally 45% Pt and 55% C, obtained in synthesis using urea:Pt ratio equal to 2.1:1 or 4:1, are presented in FIG. 29 (heat treatment at 300° C.).

The 45% Pt 55% C samples obtained in this example show excellent temperature stability, which is confirmed by unchanged activity (indicated by similar values of peak currents in the hydrogen adsorption-desorption region of CV) and also no significant changes in distribution of nanoparticle size, i.e. no significant sintering.

### Example 22. Comparison of Metal Precursor Adsorption with Adsorption of Metal-Urea Complex

10 ml of 0.01 mol l⁻¹ RhCl₃ and 0.25 ml of 1 mol l⁻¹ urea (urea:Rh ratio equal to 2.5:1) were mixed and heated at 90° C. in a Petri dish until all the liquid was evaporated. The obtained precipitate was dissolved in 10 ml of water and the evaporation-dissolution procedure was repeated two times. Next, 2.33 ml of the resulting rhodium-urea complex solution was added to 50 mg of carbon black, in order to obtain the desired rhodium:carbon mass ratio (5% Rh, 95% C). The obtained suspension was left for ca. 5 hours and, then, filtered and washed thoroughly with water. The sample was next placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm. The same procedure was applied for a second sample, where 0.01 mol l⁻¹ RhCl₃ solution was used instead of Rh-urea complex.

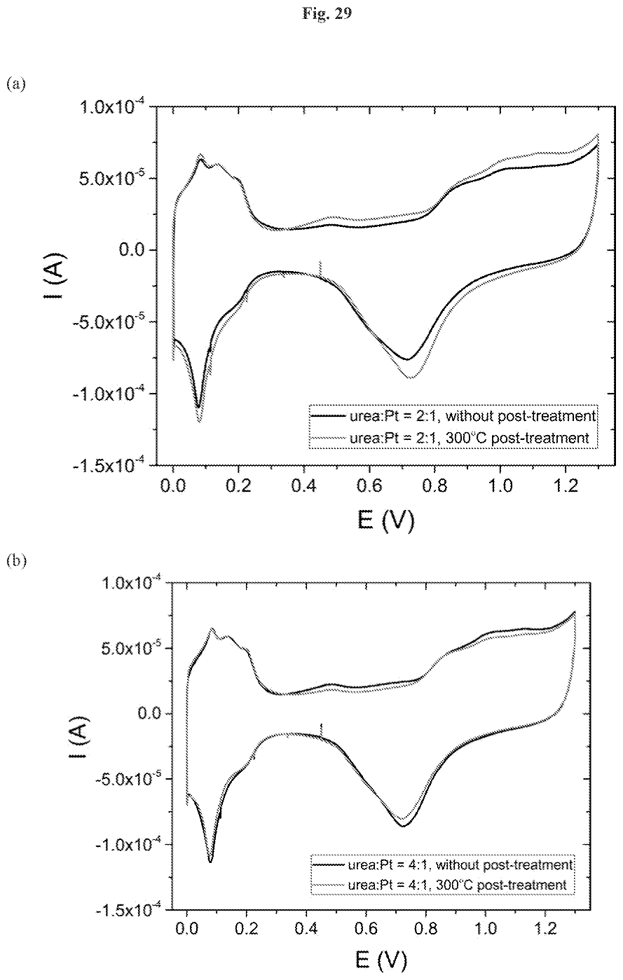

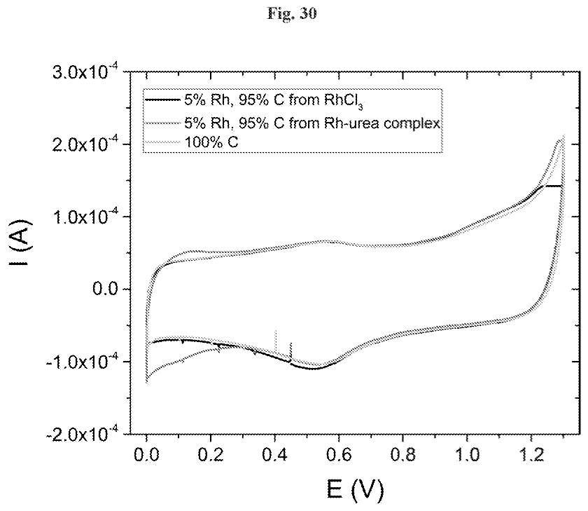

The obtained samples were investigated using cyclic voltammetry as described in Example 1. Cyclic voltammograms of a sample containing 100% carbon were measured for comparison. The examples of recorded voltammograms are presented in FIG. 30. The sample obtained using Rh-urea complex shows significantly higher activity (higher current in the hydrogen adsorption-desorption region between ca. −0.3 and −0.65 V) than the sample obtained using RhCl₃ as the adsorbed compound. The cyclic voltammogram of the sample obtained using RhCl₃ as the adsorbed compound does not significantly differ from the sample containing 100% carbon, which is most probably due to low amount of RhCl₃ adsorbed on the carbon in the adsorption step. Based on the comparison of the presented cyclic voltammograms it can be concluded that the obtained Rh-urea complex adsorbs on carbon surface more easily than the precursor salt, RhCl₃.

### Example 23. Synthesis of Carbon-Supported Pt/Ir Alloy Nanoparticles

Two solutions were prepared:
a) 10 ml of 0.01 mol l⁻¹ IrCl₄ was added to 0.21 ml of 1 mol l⁻¹ urea (urea:Ir ratio equal to 2.1:1)
b) 10 ml of 0.01 mol l⁻¹ K₂PtCl₄ was added to 0.21 ml of 1 mol l⁻¹ urea (urea:Pt ratio equal to 2.1:1)

The solution a) was heated at 80° C. until all the liquid was evaporated. Next 10 ml of water were added and the obtained solution was heated at 80° C. under reflux for 5 hours. The solution b) was heated at 80° C. until all the liquid was evaporated. Next 10 ml of water were added and the evaporation-dissolution procedure was repeated two times. The obtained solutions of Pt-urea and Ir-urea complex were left for ca. 5 hours and then added in calculated amounts to pre-weighted amounts of carbon (ca. 25 mg) in order to attain the desired platinum:iridium and metal:carbon ratio in the dry-mass of the sample. The obtained suspensions were left for ca. 15 hours and, then, filtered and washed thoroughly with water. The samples were then placed in a tube furnace, dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm.

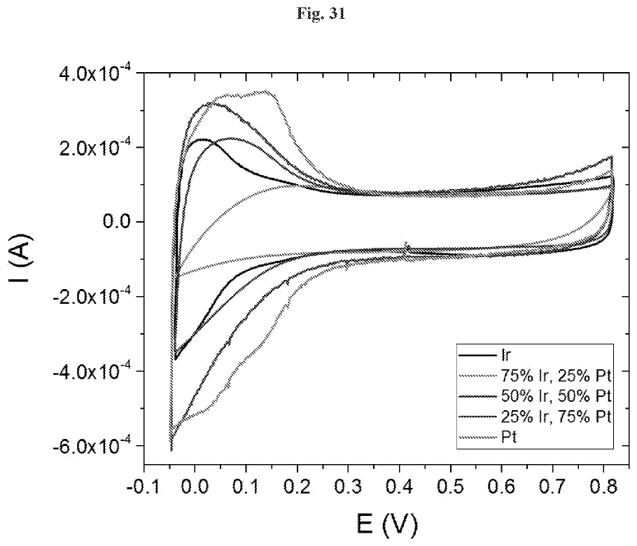

The obtained samples were investigated using cyclic voltammetry as described in Example 1. FIG. 31 presents voltammograms recorded for samples containing nominally 20% metal and 80% C and the following Pt:Ir ratios: 100% Ir; 75% Ir, 25% Pt; 50% Ir, 50% Pt; 25% Ir, 75% Pt; 100% Pt.

All the obtained samples show good activity in the hydrogen adsorption-desorption process. Based on the charge associated with hydrogen adsorption and desorption (between ca. −0.3 and −0.65 V) it can be concluded that the activity does not change linearly with Pt (or Ir) mass-content, therefore an effect of alloying on catalyst properties is observed.

### Example 24. Comparison of the Carbon-Supported Metal Nanoparticles of the Invention with Commercially Available Catalysts—Nanoparticle Size and Distribution

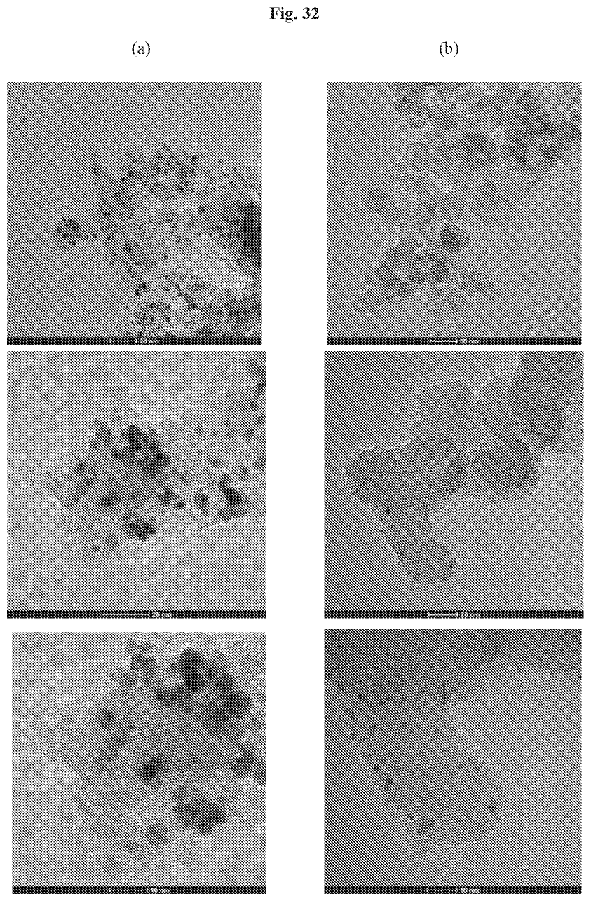

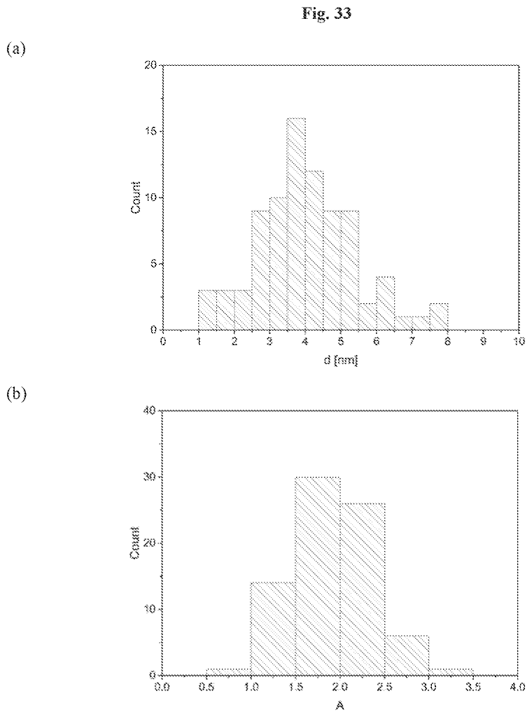

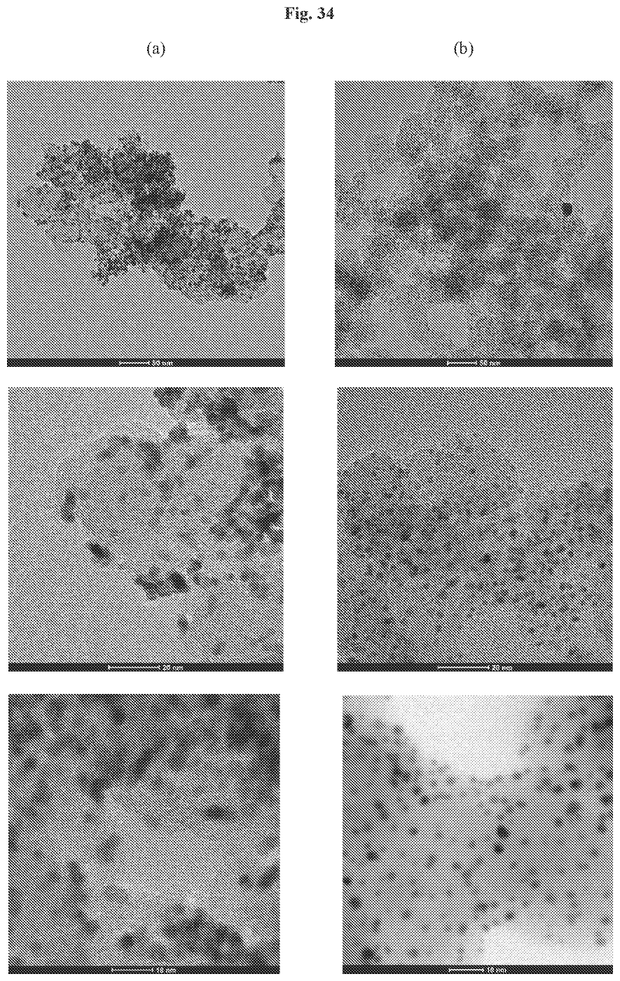

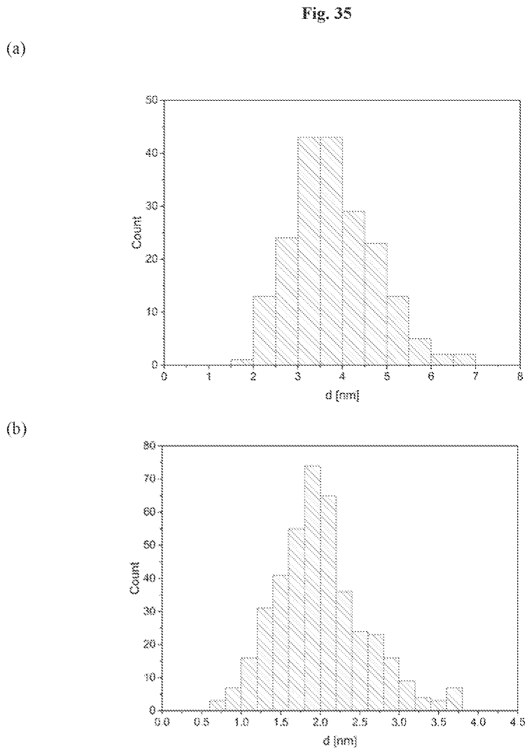

The carbon-supported metal nanoparticle of the invention were compared with commercially available catalysts. FIG. 32 presents TEM micrographs of 20% Pt 80% C (Vulcan) catalyst from BASF and 20% Pt 80% C (Vulcan®) sample obtained using the method of the invention. The corresponding Pt nanoparticle diameter histograms for both samples, which are calculated based on a 10 nm scale TEM images, are presented in FIG. 33. FIG. 34 presents TEM micrographs of 40% Pt 60% C (Vulcan®) catalyst from E-TEK and 40% Pt 60% C (Vulcan®) sample obtained using the method of the invention. The corresponding Pt nanoparticle diameter histograms for both samples, which are calculated based on a 10 nm scale TEM images, are presented in FIG. 35.

It can be seen from the comparison of the samples with the same Pt:C ratio, that the samples prepared by the method of the invention have a more uniform distribution of nanoparticles and a smaller average size of nanoparticles, as compared to the examined commercial catalysts, which translates into a higher active surface area.

### Example 25. Comparison of the Carbon-Supported Metal Nanoparticles of the Invention with Commercially Available Catalysts—Active Surface Area

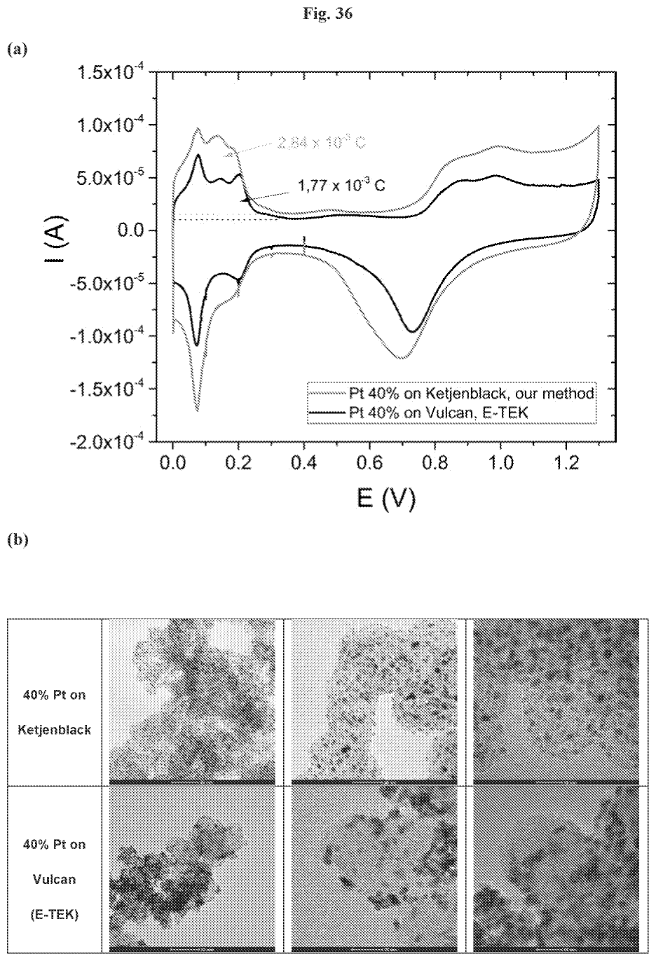

The carbon-supported metal nanoparticles of the invention were compared with a commercially available catalyst with the same Pt:C ratio (40% Pt, 60% C) using cyclic voltammetry as described in Example 1. The examples of recorded voltammograms are presented in FIG. 36. The charge values written in the Figure are the total charge values corresponding to the process of desorption of a hydrogen monolayer from the platinum catalyst surface. Based on the values of the charge, the specific active surface area of the catalysts was calculated to be 54 m² g⁻¹_{Pt} and 86 m² g⁻¹_{Pt} for the commercially available catalyst (E-TEK) and the catalyst obtained by the method of invention, respectively. The method used for the calculations was the method described by Coutanceau et al. (C. Coutanceau, S. Baranton and T. W. Napporn (2012). Platinum Fuel Cell Nanoparticle Syntheses: Effect on Morphology, Structure and Electrocatalytic Behavior, The Delivery of Nanoparticles, Dr. Abbass A. Hashim (Ed.), ISBN: 978-953-51-0615-9, InTech). In short, the current associated with hydrogen desorption (in the potential region between ca. 0.05 and 0.4 V vs RHE in the anodic scan), corrected for the current associated with double-layer charging, is integrated and divided by the scan rate used in the experiment, according to the equation:

$${Q}_{{H}_{des}} = \int i ( t ) dt = \frac{1}{v} \int i ( E ) dE$$

where Q_{Hdes} is the charge corresponding to the integrated current i, E is the electrode potential, t is time and v is the potential scan rate. Next, the active surface area of the catalyst is calculated, assuming that the charge corresponding to desorption of a hydrogen monolayer from the unit area of polycrystalline platinum is 210 μC cm⁻². Lastly, the obtained active surface area is divided by platinum mass in the sample, in order to obtain the specific active surface area.

It can be seen from the comparison of the calculated values that the sample prepared by the method of the invention has a significantly higher specific active surface area than the commercially available sample, which most probably results from a more uniform distribution of nanoparticles and a smaller average size of nanoparticles, as compared to the examined commercial catalysts. The highly developed active surface area of the catalysts obtained by the method of invention is a very important feature in terms of cost of catalyst synthesis, due to the fact that a lower mass of noble metal precursors can be used in order to obtain catalysts with desired activity.

### Example 26. Synthesis of Carbon-Supported Pt Nanoparticles Using Different Reducing Agents

10 ml of 0.01 mol l⁻¹ K₂PtCl₄ and 0.125 ml 2 mol l⁻¹ urea (urea:Ptratio equal to 2.5:1) were mixed and heated in a Petri dish at 90° C. until all the liquid evaporated. The precipitate was left for 5 minutes under fume hood without heating and, then, it was dissolved in 10 ml of water, so that a 0.01 mol l⁻¹ solution of a platinum-urea complex was obtained. The synthesis was repeated so that a total of 20 ml 0.01 mol l⁻¹ solution was obtained. The solution was left for 5 hours and, next, 6.09 ml of the obtained solution were added to three ca. 50 mg samples of carbon black in order to attain the desired metal:carbon ratio in the dry-mass of the sample (20% nominal content of Pt). The obtained suspensions of carbon in the solution of platinum-urea complex were then heated for two hours at 90° C. under reflux. Afterwards, the suspension was filtered and washed thoroughly with water. Next the samples were reduced in one of the following ways:
The sample was dried under argon atmosphere at 150° C. for 4 hours and, subsequently, reduced in hydrogen-argon mixture (10% H₂, 90% Ar) at 150° C. for 4 hours and left to cool down to ambient temperature under argon atmosphere. The flow rate of the gaseous stream (argon or hydrogen-argon mixture) was 15 sccm.
6.09 ml of 0.1 M citric acid was added and the sample was heated at 60° C. under reflux for one hour (citric acid:Pt ratio equal to ca. 10:1).
6.09 ml of 0.1 M L-ascorbic acid was added and the sample was heated at 60° C. under reflux for one hour (L-ascorbic acid:Pt ratio equal to ca. 10:1).

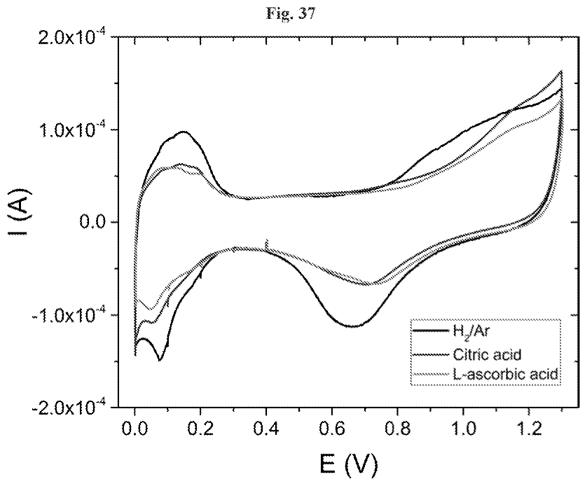

The obtained samples were investigated using cyclic voltammetry as described in Example 1. The examples of recorded voltammograms are presented in FIG. 37. Reduction with H₂ is more beneficial than with citric acid or L-ascorbic acid.

### Example 27. Synthesis of Carbon-Supported Ir Nanoparticles Using Thermal Decomposition of Adsorbed Ir-Urea Complex

10 ml of 0.01 mol l⁻¹ fresh IrCl₄ solution and 0.25 ml of 1 mol l⁻¹ urea (urea:Ir ratio equal to 2.5:1) were mixed and heated at 90° C. in a Petri dish until all the liquid was evaporated. The obtained precipitate was dissolved in 10 ml of water. Next, 4.28 ml of the resulting iridium-urea complex solution was added to 32.6 mg of carbon black, in order to obtain the desired iridium:carbon mass ratio (21% Ir, 79% C).

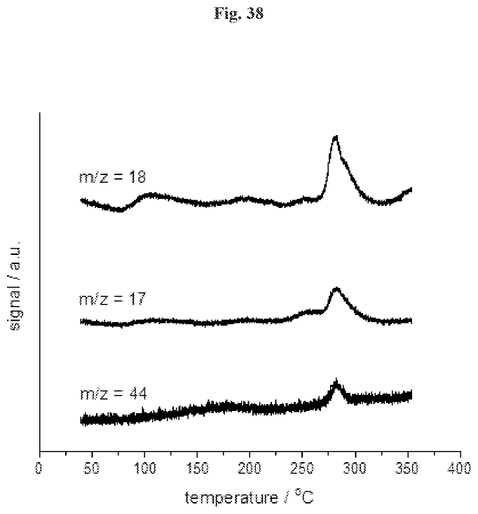

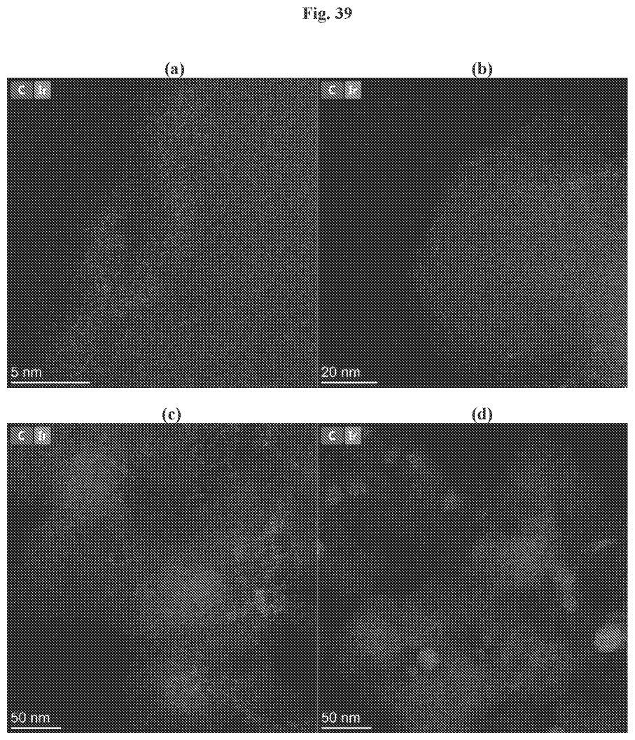

The obtained suspensions were left for ca. 15 hours and, then, filtered and washed thoroughly with deionized water. The sample was then placed in a tube furnace, dried under vacuum at 70° C. for 4 hours and, subsequently, heated under argon at temperature 350° C. for 2 h and temperature rise rate of 0.6° C./min. The flow rate of argon was 30 sccm. During the decomposition phase the decomposition products were monitored using mass spectrometry. As can be seen on FIG. 38 adsorbed Ir-urea complex decomposes to ammonia and carbon dioxide above 270° C. The same procedure was utilized to remove the excess of urea from carbon substrate.

### Example 28. Synthesis of Carbon-Supported Cu/Pd Alloy Nanoparticles on Carbon Support

Pre-weighted amount (ca. 100 mg) of carbon black was transferred to a small beaker containing 20 ml of 2 mM water solution of Cu(NO₃)₂ and left for 30 minutes and, afterwards, filtered and washed thoroughly with water. 10 ml of 0.01 mol l⁻¹ K₂PdCl₄ and 0.25 ml of 1 mol l⁻¹ solution of urea were mixed and heated in a Petri dish at 80° C. until all the liquid evaporated. The precipitate was dissolved in 10 ml of water and the evaporation/dissolution procedure was repeated two times. 2.26 ml of the obtained solution was added to the beaker containing copper precursor deposited on carbon in order to attain the desired metal:carbon ratio in the dry-mass of the sample (2.5% of Cu, 2.5% Pd, 90% C). The obtained suspensions of Cu/carbon in the solution of palladium-urea complex were left for 30 minutes and, afterwards, filtered and washed thoroughly with water. The sample was then placed in a tube furnace, dried under argon atmosphere at 100° C. for 4 hours and, subsequently, reduced in hydrogen-argon mixture (10% H₂, 90% Ar) at 50, 100 or 150° C. for 4 hours and left to cool down to ambient temperature under argon atmosphere. The flow rate of the gaseous stream (argon or hydrogen-argon mixture) was 15 sccm.

1.-35. (canceled)

36. A method of synthesis of carbon-supported platinum group metal or platinum group metal alloy nanoparticles, which comprises the following steps:
(b) adsorption of complexes of platinum group metals with a urea complexing agent on carbon support, wherein the urea complexing agent is selected from a group comprising urea, urea derivative, a mixture of urea with at least one urea derivative, and a mixture of at least two urea derivatives; and
(c) reduction of the complexes of a platinum group metal with a urea complexing agent adsorbed in step (b) on the carbon support to metal nanoparticles with the formation of a product of carbon-supported metal nanoparticles.

37. The method of claim 36, wherein in step (b) adsorption of complexes of a platinum group metal with a urea complexing agent on the carbon support is accompanied by adsorption of other precursors of platinum group metals.

38. The method of claim 36 or 37, wherein in step (b) adsorption of complexes of a platinum group metal with a urea complexing agent on the carbon support is accompanied by adsorption of precursors of metals other than platinum group metals.

39. The method of any of claims 36-38, wherein complexes of a platinum group metal with a urea complexing agent include mixed complexes, in which other ligands are present in addition to urea or urea derivatives.

40. The method of claim 36, wherein step (b), adsorption of metal-urea complexing agent complexes onto carbon support, is carried out in an aqueous solution.

41. The method of claim 36, wherein steps (b) and (c) are preceded by step (a) of complex formation by reacting in a solution a platinum group metal precursor with a urea complexing agent selected from a group comprising urea, urea derivative, a mixture of urea with at least one urea derivative, and a mixture of at least two urea derivatives.

42. The method of claim 41, wherein steps (a) and (b) are carried out concurrently by mixing platinum group metal precursor and urea complexing agent with carbon support to form a suspension, which is subsequently heated, so that the complexes of a platinum group metal with a urea complexing agent are formed and adsorbed on the carbon-support, wherein the adsorbed complexes of a platinum group metal with a urea complexing agent undergo the reduction step (c) resulting in formation of metal nanoparticles.

43. The method of claim 41, wherein step (a) and (b) are carried out separately, and the complexes of a platinum group metal with a urea complexing agent obtained in step (a) are subsequently mixed with the carbon support to enable adsorption of complexes of a platinum group metal with a urea complexing agent onto the carbon support, which undergoes reduction in step (c) resulting in formation of metal nanoparticles.

44. The method of any of claims 41-43, wherein step (a) of the metal-urea complexing agent complex formation is carried out in an aqueous solution.

45. The method of claim 36, wherein reduction in step (c) is carried out by using gaseous hydrogen.

46. The method of claim 45, wherein reduction in step (c) is carried out in temperature of 50-200° C. by placing the carbon support with adsorbed complexes of a platinum group metal with a urea complexing agent in a stream of a gas mixture of hydrogen with an inert gas.

47. The method of claim 46, wherein the gas mixture contains 1-10% of hydrogen.

48. The method of claim 46, wherein the reduction is carried out for 1 to 6 hours.

49. The method of claim 46, wherein the inert gas is argon or nitrogen.

50. The method of any of claims 36-39, wherein reduction in step (c) is carried out by thermal decomposition of adsorbed metal-urea complexing agent in inert atmosphere.

51. The method of claim 50, wherein reduction in step (c) is carried out in temperature of 190-600° C. by placing the carbon support with adsorbed complexes of a platinum group metal with a urea complexing agent in a stream of an inert gas.

52. The method of claim 51, wherein the inert gas is argon or nitrogen.

53. The method of any of claims 36-39, wherein reduction in step (c) is carried out in a solution by using a reducing agent.

54. The method of claim 53, wherein the reducing agent is L-ascorbic acid or citric acid.

55. The method of claim 41, wherein a molar ratio of urea complexing agent to metal used in step (a) is in the range 1-20:1.

56. The method of any of claims 36-39, wherein the amounts of complexes of a platinum group metal with a urea complexing agent and carbon support in step (b) are adjusted to obtain the product comprising 0.001 to 60% of metal by weight calculated based on the total weight of the product.

57. The method of claim 41, wherein the concentrations of the metal precursors and urea complexing agents in the solution used in step (a) are in a range from 1 mM to 5 M.

58. The method of claim 41, wherein in step (a) the solution comprising a platinum group metal precursor and urea or urea derivative is heated at 40 to 100° C. under reflux.

59. The method of claim 58, wherein in step (a) the solution comprising a platinum group metal precursor and urea complexing agents is heated for 10 minutes-10 hours.

60. The method of claim 41, wherein in step (a) the solution comprising a platinum group metal precursor and urea complexing agent is heated at 40 to 100° C. until all the liquid evaporates.

61. The method of claim 41, wherein in step (a) an organic solvent is added to the solution in a volumetric ratio of 0.05-30:1 calculated based on water volume in the solution.

62. The method of claim 41, wherein the metal precursor is selected from a group comprising K₂PtCl₄, K₂PdCl₄ and IrCl₄.

63. The method of any of claims 36-39, wherein the urea derivative is a compound containing a —HN—CO— or —HN—CO—NH— functional group.

64. The method of claim 63, wherein the urea derivative is selected from a group consisting of methylurea, N,N-dimethylurea, N,N′-dimethylurea, ethylurea, trimethylurea, N,N-diethylurea, N,N′-diethylurea, N,N′-bis(hydroxymethyl)urea, bis(hydroxymethyl)urea.

65. Use of carbon-supported platinum group metal or metal alloy nanoparticles obtained by the method of claims 36-39 as catalysts.

66. Catalysts comprising carbon-supported platinum group metal or metal alloy nanoparticles obtained by the method of claims 36-39.

67. A method of adsorption of precursors of platinum group metals on the surface of a carbon support, wherein the carbon support is immersed in a solution of complexes of platinum group metals with urea complexing agent, the urea complexing agent being selected from a group comprising urea, urea derivative, a mixture of urea with at least one urea derivative, and a mixture of at least two urea derivatives.

68. The method of claim 67, wherein the complex of platinum group metals with urea complexing agent is formed by reacting in a solution a platinum group metal precursor with a urea complexing agent selected from a group comprising urea, urea derivative, a mixture of urea with at least one urea derivative, and a mixture of at least two urea derivatives.

69. The method of claim 68, wherein formation of the complex of platinum group metals with urea complexing agent is carried in the presence of the carbon support and the complexes of a platinum group metal with a urea complexing agent are adsorbed on the carbon-support directly after formation.

70. Use of complexes of platinum group metals with urea complexing agent for adsorption of platinum group metal precursors on carbon support.
